(19) United States
(12) Patent Application Publication
(10) Pub. No.: US 2026/0326495 A1
(43) Pub. Date: Oct. 22, 2026

(54) CONTROL DEVICE

(71) Applicant: Hitachi Astemo, Ltd., Ibaraki (JP)

(72) Inventors: Yuki YOSHIDA, Ibaraki (JP); Ryusuke HIRAO, Ibaraki (JP)

(21) Appl. No.: 19/106,017

(22) PCT Filed: Dec. 8, 2023
(86) PCT No.: PCT/JP2023/043965

§ 371 Date: Feb. 24, 2025

(30) Foreign Application Priority Data
Dec. 26, 2022 (JP) 2022-207940

(51) Int. Cl. B60G 17/018

(52) U.S. Cl. CPC B60G 17/018; B60G 2400/0512; B60G 2400/252; B60G 2400/61; B60G 2400/821; B60G 2800/70

(57) ABSTRACT

A controller includes: a weight coefficient calculation unit which calculates a weight coefficient for causing actual target damping force to approach a value close to a target damping force obtained in advance; a vertical motion calculation unit which obtains a motion state of a vehicle in a vertical direction; a pitch motion calculation unit which obtains a motion state of the vehicle in a pitch direction; an actual target damping force calculation unit which calculates the actual target damping force based on the weight coefficient calculated by the weight coefficient calculation unit and a calculation result of the vertical motion calculation unit and a calculation result of the pitch motion calculation unit; a target damping coefficient calculation unit; a correction unit which calculates a corrected damping coefficient; and a control signal output unit which outputs a control signal corresponding to the corrected damping coefficient to a damping-force adjustable shock absorber.

### TECHNICAL FIELD

The present disclosure relates to a control device which controls a damping-force adjustable shock absorber of, for example, a four-wheeled vehicle.

### BACKGROUND ART

There has been known a control device which controls damping-force adjustable shock absorbers each interposed between a vehicle body and a wheel of a vehicle (Patent Literature 1 and Patent Literature 2). The related-art control device controls a damping force and the like of each of the damping-force adjustable shock absorbers so that vibration in a vertical direction of the vehicle body is suppressed.

### CITATION LIST

### Patent Literature

PTL 1: JP 2014-69759 A
PTL 2: JP 2011-131876 A

### SUMMARY OF INVENTION

### Technical Problem

Incidentally, the related-art control device executes, for example, bilinear optimal control (BLQ) in order to suppress the vibration of the vehicle body in the vertical direction. At this time, it is preferred that, in addition to the vibration in the vertical direction (heave), the control device be capable of suppressing vibration in pitch. However, in order to use the BLQ to suppress the vibration in the pitch in addition to the vibration in the vertical direction, it is required to execute optimization through use of a full-vehicle model, and hence there is a problem of poor tunability. Meanwhile, in skyhook control, there has been known control which uses a gain scheduling parameter (GSP). However, when the GSP is applied to the BLQ, the number of controllers becomes two, and hence there is a problem of poor controllability.

One object of the present invention is to provide a control device for a damping-force adjustable shock absorber capable of suppressing vibration in a vertical direction and pitch while tunability is secured.

### Solution to Problem

According to one embodiment of the present invention, there is provided a control device for a damping-force adjustable shock absorber which is provided to a vehicle and which allows adjustment of a damping force to be generated, the control device including: a weight coefficient calculation unit configured to calculate, when an actual target damping force is to be calculated based on a calculated value of a vehicle behavior calculation unit, a weight coefficient for causing the actual target damping force to approach a value close to a target damping force obtained in advance; a vertical motion calculation unit configured to obtain a motion state of the vehicle in a vertical direction; a pitch motion calculation unit configured to obtain a motion state of the vehicle in a pitch direction; an actual target damping force calculation unit configured to calculate the actual target damping force based on the weight coefficient calculated by the weight coefficient calculation unit and a calculation result of the vertical motion calculation unit and a calculation result of the pitch motion calculation unit; a target damping coefficient calculation unit configured to calculate a target damping coefficient based on a calculated value of the actual target damping force calculation unit; a correction unit configured to calculate a corrected damping coefficient obtained by reducing an upper limit of the target damping coefficient in a region in which a relative speed between a sprung part and an unsprung part of the vehicle is lower than a predetermined value; and a control signal output unit configured to output a control signal corresponding to the corrected damping coefficient to the damping-force adjustable shock absorber. The control device is characterized in that: the correction unit is configured to set the corrected damping coefficient such that the damping force increases in accordance with an increase in the relative speed, a gradient of the damping force with respect to the relative speed is small when the relative speed is lower than the predetermined value, and the gradient of the damping force with respect to the relative speed is large when the relative speed is higher than the predetermined value; and the correction unit has a maximum damping coefficient corresponding to the relative speed, and is configured to correct the target damping coefficient to the maximum damping coefficient when the target damping coefficient exceeds the maximum damping coefficient.

According to the one embodiment of the present invention, it is possible to suppress vibration in the vertical direction and the pitch while tunability is secured.

### BRIEF DESCRIPTION OF DRAWINGS

FIG. 1 is an overall configuration diagram for illustrating a four-wheeled vehicle to which a controller according to embodiments of the present invention is applied.

FIG. 2 is a diagram for schematically illustrating a vehicle behavior control device in the embodiments of the present invention.

FIG. 3 is a control block diagram for illustrating a controller according to a first embodiment of the present invention.

FIG. 4 is a block diagram for illustrating a GSP calculation unit of FIG. 3.

FIG. 5 is a block diagram for illustrating a BLQ controller of FIG. 3.

FIG. 6 is an explanatory graph for showing a damping coefficient upper limit calculation unit of FIG. 5.

FIG. 7 is an explanatory graph for showing a command value calculation unit of FIG. 5.

FIG. 8 is a block diagram for illustrating a target damping force calculation unit and a corrected damping coefficient calculation unit of FIG. 5.

FIG. 9 is a block diagram for illustrating a sprung vertical damping BLQ of FIG. 5.

FIG. 10 is a block diagram for illustrating a roll damping BLQ of FIG. 5.

FIG. 11 is a block diagram for illustrating a pitch damping BLQ of FIG. 5.

FIG. 12 is an explanatory diagram for illustrating a vehicle model to be used for design of the sprung vertical damping BLQ.

FIG. 13 is an explanatory diagram for illustrating a vehicle model to be used for design of a roll damping BLQ.

FIG. 14 is an explanatory diagram for illustrating a vehicle model to be used for design of a pitch damping BLQ.

FIG. 15 is a characteristic chart for showing an example of temporal changes in a sprung displacement, a sprung acceleration, a pitch angle, a right front wheel command electric current, and a right rear wheel command electric current in the first embodiment and a comparative example.

FIG. 16 is a control block diagram for illustrating a controller according to a second embodiment of the present invention.

FIG. 17 is a block diagram for illustrating a GSP calculation unit of FIG. 16.

FIG. 18 is a control block diagram for illustrating a controller according to a third embodiment of the present invention.

FIG. 19 is a block diagram for illustrating a BLQ controller of FIG. 18.

FIG. 20 is a block diagram for illustrating a sprung vertical damping BLQ of FIG. 19.

FIG. 21 is a block diagram for illustrating a roll damping BLQ of FIG. 19.

FIG. 22 is a block diagram for illustrating a pitch damping BLQ of FIG. 19.

### DESCRIPTION OF EMBODIMENTS

With reference to the accompanying drawings, a detailed description is now given of a control device according to each embodiment of the present invention while exemplifying a case in which this control device is applied to a four-wheeled vehicle.

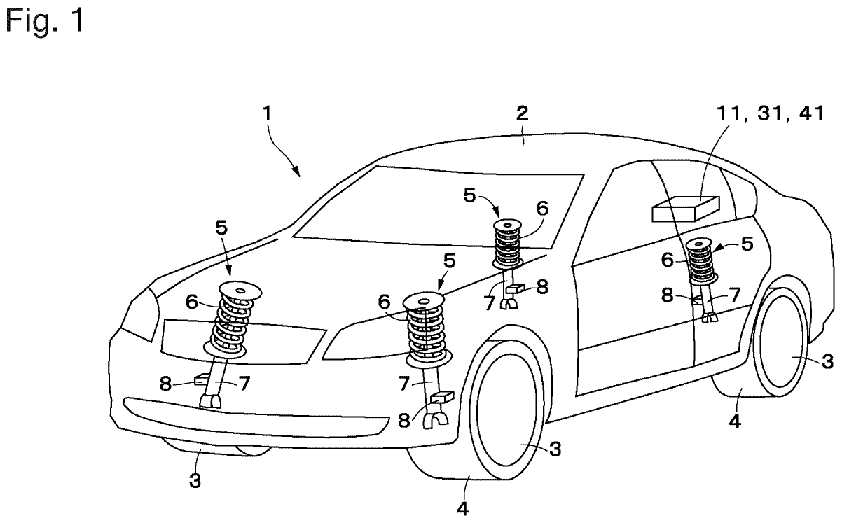

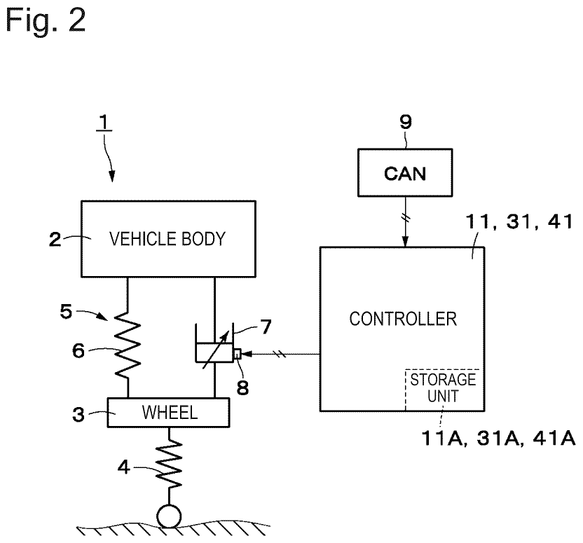

FIG. 1 is a diagram for illustrating a vehicle to which a controller 11 being a control device is applied. To this vehicle, a vehicle behavior control device 1 including the controller 11 is applied. As illustrated in FIG. 2, the vehicle behavior control device 1 includes suspension devices 5 each of which forms a damping force generation device and the controller 11 which forms a vehicle control device. Here, in FIG. 2, on a lower side of a vehicle body 2 forming a body of a vehicle, there are provided, for example, right and left front wheels and right and left rear wheels (hereinafter collectively referred to as “wheel 3”). Those wheels 3 each include a tire 4. This tire 4 acts as a spring for absorbing fine roughness of a road surface.

A suspension device 5 is provided in such a manner as to be interposed between the vehicle body 2 of the vehicle and the wheel 3 of the vehicle. The suspension device 5 includes a suspension spring 6 (hereinafter referred to as “spring 6”) and a damping-force adjustable shock absorber (hereinafter referred to as “variable damper 7”) arranged in a parallel relationship with the spring 6 and provided between the vehicle body 2 and the wheel 3.

In FIG. 2, a case in which one set of the suspension device 5 is provided between the vehicle body 2 and the wheel 3 is illustrated. However, for example, a total of four sets of suspension devices 5 are individually and independently provided between the four wheels 3 and the vehicle body 2, and only one set thereof is schematically illustrated in FIG. 2.

Here, the variable damper 7 of the suspension device 5 is formed through use of a hydraulic shock absorber of a damping force adjustable type provided in such a manner as to be interposed between the vehicle body 2 and the wheel 3. To the variable damper 7, a damping force variable actuator 8 formed of a damping-force adjustment valve and the like is provided in order to continuously adjust a characteristic (that is, damping force characteristic) of the generated damping force from a hard characteristic to a soft characteristic. The variable damper 7 forms a force generation mechanism which generates an adjustable force between the vehicle body 2 and the wheel 3. It is not always required that the damping force variable actuator 8 be configured to continuously adjust the damping force characteristic, and may be configured to adjust the damping force at a plurality of levels, for example, two or more levels. Moreover, the variable damper 7 may be of a pressure control type or a flow rate control type. The variable damper 7 may be of a type which controls viscosity, such as a magneto-viscous fluid or an electro-viscous fluid.

The controller 11 forms a control device for the variable damper 7, and controls a damping characteristic of the variable damper 7. The controller 11 is formed of, for example, a microcomputer. The controller 11 is connected to, for example, a controller area network (CAN) 9 being a line network required for data communication. The controller 11 acquires specifications relating to the travel of the vehicle through the CAN 9. At this time, the specifications relating to the travel of the vehicle include, for example, a wheel speed, a slip rate, a forward/backward acceleration, an engine torque, a brake hydraulic pressure, a road surface friction coefficient, and braking/driving force control flags independently for the four wheels. An output side of the controller 11 is connected to the damping force variable actuator 8 of the variable damper 7.

Moreover, the controller 11 includes a storage unit 11A formed of a ROM, a RAM, a nonvolatile memory, and the like. In the storage unit 11A of the controller 11, various programs, information (vehicle information), data, and the like for controlling the variable dampers 7 are stored.

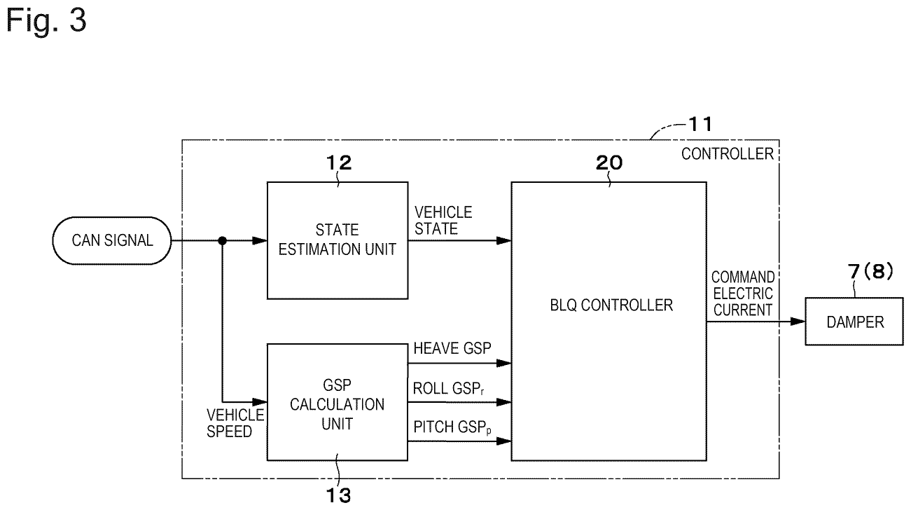

As illustrated in FIG. 3, the controller 11 includes a state estimation unit 12, a GSP calculation unit 13, and a BLQ controller 20.

The state estimation unit 12 uses a CAN signal to estimate a vehicle state (vehicle motion and vehicle behavior). That is, the state estimation unit 12 estimates an inter-sprung part-unsprung part relative speed, a vehicle body absolute vertical speed (sprung speed), an inter-unsprung part-road surface relative speed, an unsprung absolute vertical speed (unsprung speed), a roll rate, a roll angle, a pitch rate, and a pitch angle based on the signal (CAN signal) flowing through the CAN 9. For example, the state estimation unit 12 estimates the inter-sprung part-unsprung part relative speed, the vehicle body absolute vertical speed, the inter-unsprung part-road surface relative speed, the unsprung absolute vertical speed, the roll rate, the roll angle, the pitch rate, and the pitch angle based on a steering angle, the forward/backward acceleration, a leftward/rightward acceleration, a yaw rate, the wheel speed of each wheel 3, absence/presence of a brake operation, and a master cylinder hydraulic pressure of the vehicle.

A technology of using a vehicle model (motion equations) obtained by modeling the vehicle from the forward/backward acceleration, the leftward/rightward acceleration, the yaw rate, the wheel speeds, and the like, the Kalman filter, and the like to estimate the inter-sprung part-unsprung part relative speed, the vehicle body absolute vertical speed, the inter-unsprung part-road surface relative speed, the unsprung absolute vertical speed, the roll rate, the roll angle, the pitch rate, the pitch angle, and the like is described in various literatures (literatures relating to the estimation of the vehicle state) including, for example, JP 2012-47553 A, and hence a further description is omitted.

The state estimation unit 12 forms a vehicle behavior calculation unit which calculates the vehicle behavior. Specifically, the state estimation unit 12 includes a vertical motion calculation unit which obtains a state relating to a motion of the vehicle in the vertical direction. The state estimation unit 12 includes a roll motion calculation unit which obtains a state relating to a motion of the vehicle in a roll direction. The state estimation unit 12 includes a pitch motion calculation unit which obtains a state relating to a motion of the vehicle in a pitch direction. The state estimation unit 12 includes a posture change detection unit which detects a posture change of the vehicle body.

The state estimation unit 12 outputs, to the BLQ controller 20, signals corresponding to the estimated state values (motion values), that is, the inter-sprung part-unsprung part relative speed, the vehicle body absolute vertical speed, the inter-unsprung part-road surface relative speed, the unsprung absolute vertical speed, the roll rate, the roll angle, the pitch rate, the pitch angle, and the like.

The vehicle behavior calculation unit may be various sensors which detect the sprung speed, the roll rate, the pitch rate, and the like. Moreover, the vehicle behavior calculation unit may estimate a sprung acceleration, the roll rate, the pitch rate, and the like based on the wheel speeds and road surface information (preview) in a travel direction of the vehicle.

The GSP calculation unit 13 (gain scheduling parameter calculation unit) forms a weight coefficient calculation unit which calculates weight coefficients for causing an actual target damping force based on the calculated values of the state estimation unit 12 (vehicle behavior calculation unit) to approach a value close to a target damping force obtained in advance. The GSP calculation unit 13 calculates a heave GSP, a roll GSPᵣ, and a pitch GSPₚ based on, for example, the vehicle speed acquired from the CAN 9. The heave GSP is a weight coefficient for adjusting a heave target damping force for suppressing the motion of the vehicle in the vertical direction. The roll GSPᵣ is a weight coefficient for adjusting a roll target damping force for suppressing the motion of the vehicle in the roll direction. The pitch GSPₚ is a weight coefficient for adjusting a pitch target damping force for suppressing the motion of the vehicle in the pitch direction.

That is, the GSP calculation unit 13 calculates, when the BLQ controller 20 obtains the actual target damping force based on the vehicle state being the calculated values of the state estimation unit 12 (vehicle behavior calculation unit) (for example, the inter-sprung part-unsprung part relative speed, the vehicle body absolute vertical speed, the inter-unsprung part-road surface relative speed, the unsprung absolute vertical speed, the roll rate, the roll angle, the pitch rate, the pitch angle, and the like), the weight coefficients (heave GSP, roll GSPᵣ, and pitch GSPₚ) for causing the actual target damping force to approach a value close to the target damping force obtained in advance. The GSP calculation unit 13 outputs the heave GSP, the roll GSPᵣ, and the pitch GSPₚ to the BLQ controller 20.

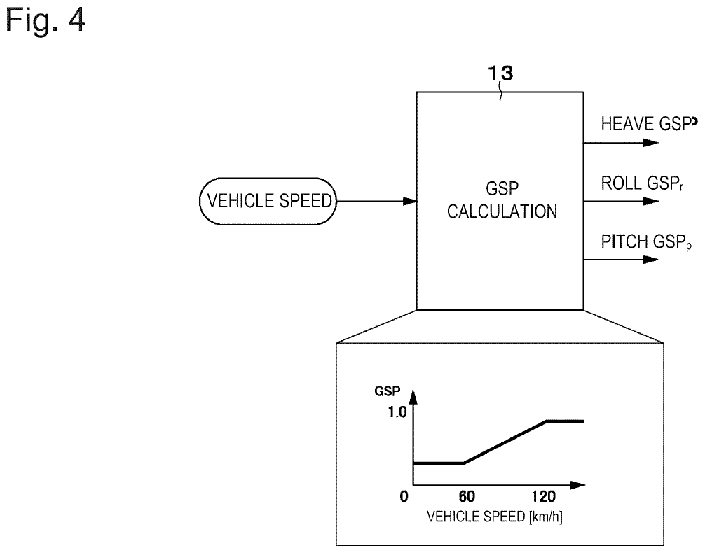

As illustrated in FIG. 4, the GSP calculation unit 13 includes, for example, a lookup table which records a relationship between the vehicle speed and the heave GSP. In this configuration, the heave GSP has been determined through tuning in an actual vehicle test. Specifically, a rough characteristic of the heave GSP has been determined through sensory evaluation in the actual vehicle test, and then, the heave GSP is finely adjusted by referring to vibration data and the like. Moreover, the GSP calculation unit 13 includes a lookup table which records a relationship between the vehicle speed and the roll GSP and a lookup datable which records a relationship between the vehicle speed and the pitch GSP. The roll GSPᵣ and the pitch GSPₚ have also been determined through the tuning in the actual vehicle test as in the case of the heave GSP.

Each of the heave GSP, the roll GSPᵣ, and the pitch GSPₚ has a value normalized to a range of from 0 to 1. For example, as illustrated in FIG. 4, each of the heave GSP, the roll GSPᵣ, and the pitch GSPₚ takes a small value at a low speed, and takes a large value at a high speed. The value of each of the heave GSP, the roll GSPᵣ, and the pitch GSPₚ is not limited to this example, and may have a constant value with the same value independently of the vehicle speed.

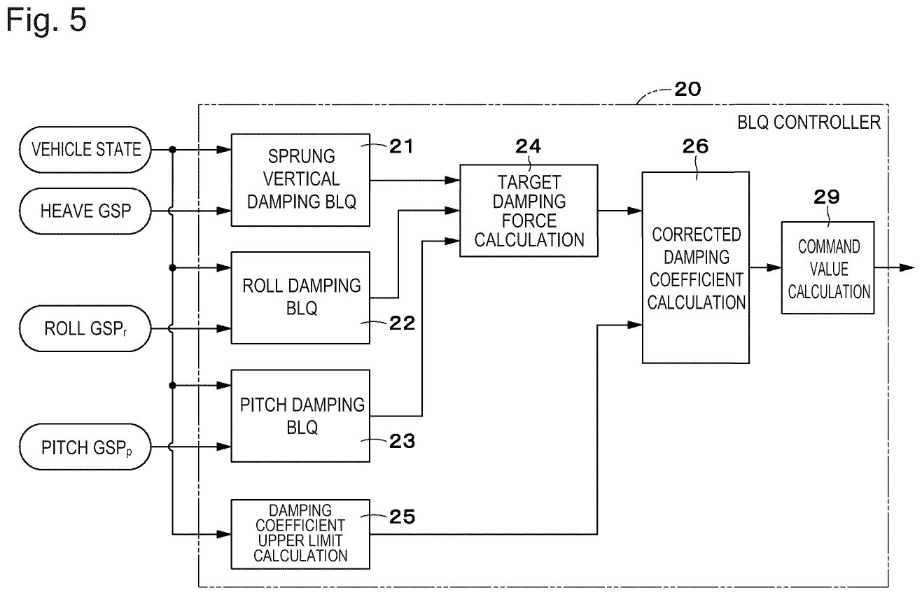

The BLQ controller 20 calculates a command electric current (control signal) serving as a command value based on the bilinear optimal control theory. As illustrated in FIG. 5, the BLQ controller 20 includes a sprung vertical damping BLQ 21, a roll damping BLQ 22, a pitch damping BLQ 23, a target damping force calculation unit 24, a damping coefficient upper limit calculation unit 25, a corrected damping coefficient calculation unit 26, and a command value calculation unit 29.

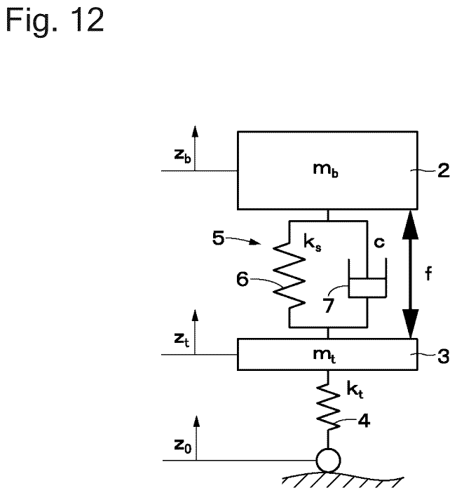

To the sprung vertical damping BLQ 21, the vehicle state output from the state estimation unit 12 and the heave GSP output from the GSP calculation unit 13 are input. The sprung vertical damping BLQ 21 calculates the heave target damping force of the variable damper 7 for reducing vertical vibration based on the inter-sprung part-unsprung part relative speed, the vehicle body absolute vertical speed, the inter-unsprung part-road surface relative speed, and the unsprung absolute vertical speed output from the state estimation unit 12 and the heave GSP output from the GSP calculation unit 13. The sprung vertical damping BLQ 21 is designed based on, for example, a vehicle model illustrated in FIG. 12. In FIG. 12, the case in which one set of the suspension device 5 is provided between the vehicle body 2 and the wheel 3 is exemplified. However, for example, the total of four sets of the suspension devices 5 are individually and independently provided between the four wheels 3 and the vehicle body 2, and only one set thereof is schematically illustrated in FIG. 12. The sprung vertical damping BLQ 21 is designed based on a state equation for the vehicle model of FIG. 12 as indicated in a design method described later.

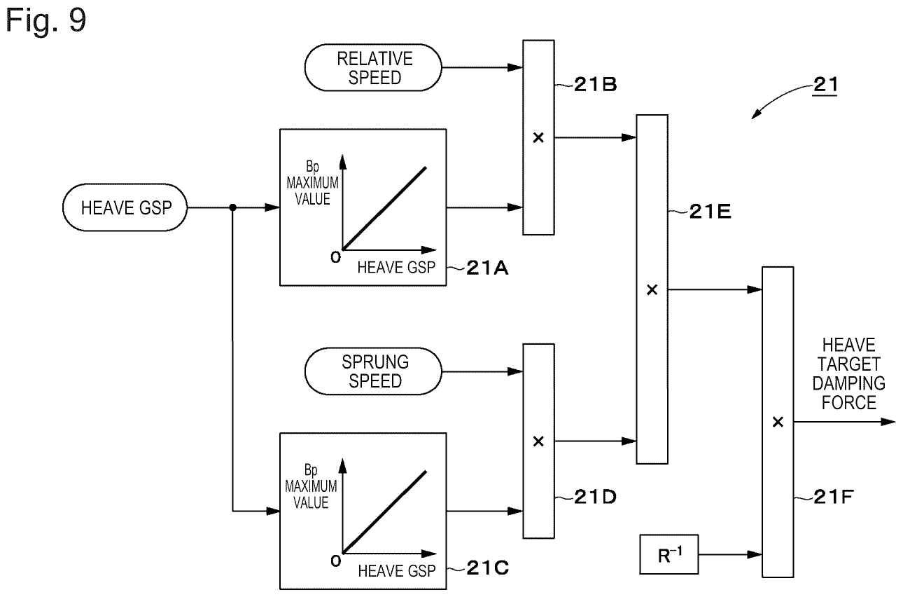

As illustrated in FIG. 9, the sprung vertical damping BLQ 21 includes a Bp calculation unit 21A, a multiplier 21B, a Bp calculation unit 21C, a multiplier 21D, a multiplier 21E, and a heave target damping force calculation unit 21F. The Bp calculation unit 21A obtains, based on Bp obtained in advance and the heave GSP, the maximum value of Bp corresponding to the relative speed. The multiplier 21B multiplies the maximum value of Bp output from the Bp calculation unit 21A and the relative speed by each other. The Bp calculation unit 21C obtains, based on Bp obtained in advance and the heave GSP, the maximum value of Bp corresponding to the sprung speed. The multiplier 21D multiplies the maximum value of Bp output from the Bp calculation unit 21C and the sprung speed by each other. The multiplier 21E multiplies a calculated value obtained by the multiplier 21B and a calculated value obtained by the multiplier 21D by each other. The heave target damping force calculation unit 21F multiplies a calculated value obtained by the multiplier 21E and an inverse matrix (R⁻¹) of R obtained in advance by each other, to thereby calculate the heave target damping force. In the manner described above, the sprung vertical damping BLQ 21 calculates a value obtained by multiplying a right side of Expression 12 given later by the relative speed from the left. As a result, the sprung vertical damping BLQ 21 calculates a heave target damping force obtained by multiplying a left side of Expression 12 given later by the relative speed from the left. The case in which the sprung vertical damping BLQ 21 calculates the heave target damping force based on Bp corresponding to the relative speed and Bp corresponding to the sprung speed has been exemplified, but the present invention is not limited to this example. The sprung vertical damping BLQ 21 may calculate the heave target damping force based on Bp corresponding to another vehicle state in addition to Bp corresponding to the relative speed and Bp corresponding to the sprung speed.

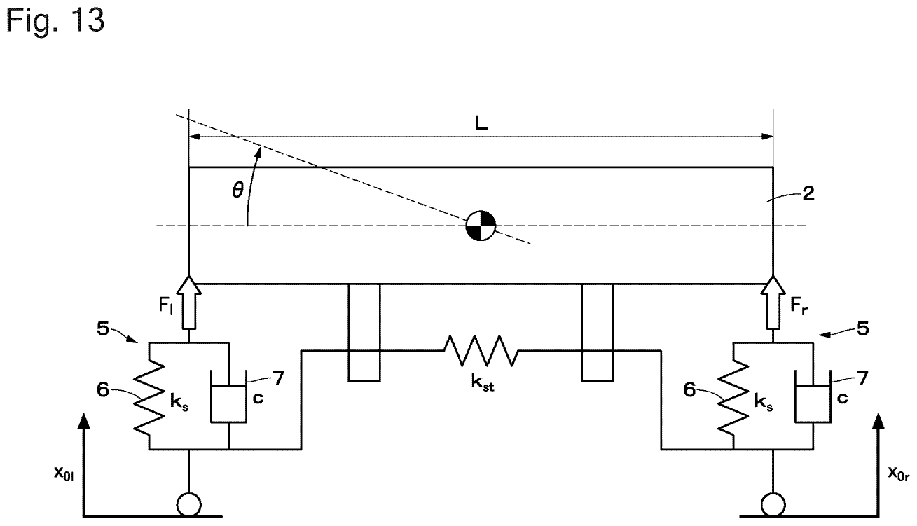

To the roll damping BLQ 22, the vehicle state output from the state estimation unit 12 and the roll GSPᵣ output from the GSP calculation unit 13 are input. The roll damping BLQ 22 calculates the roll target damping force of the variable damper 7 for reducing roll vibration based on the roll rate and the roll angle output from the state estimation unit 12 and the roll GSPᵣ output from the GSP calculation unit 13. The roll damping BLQ 22 is designed based on, for example, a vehicle model illustrated in FIG. 13. In FIG. 13, a single-degree-of-freedom rotational motion model which is the simplest is exemplified as a vehicle model which considers the roll. In an actual vehicle, a total of two sets of the motion models are respectively provided to a front wheel side and a rear wheel side, and only one set thereof is schematically illustrated in FIG. 13. The roll damping BLQ 22 is designed based on a state equation for the vehicle model of FIG. 13 as indicated in the design method described later.

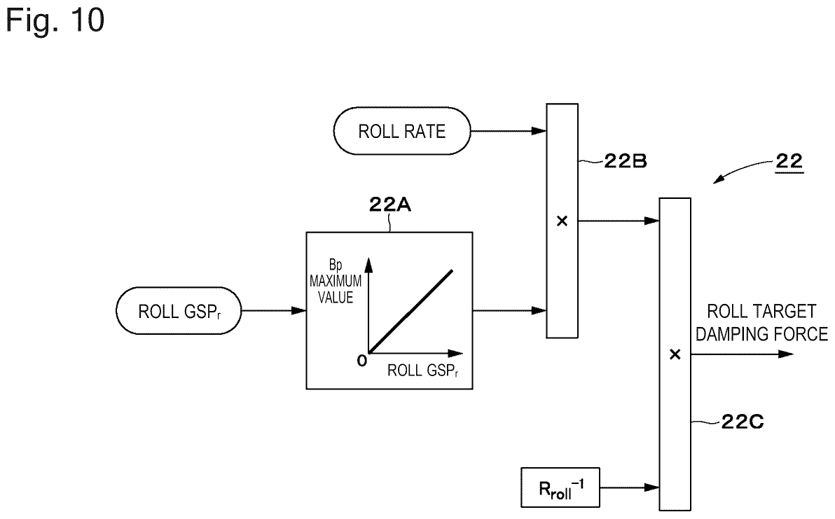

As illustrated in FIG. 10, the roll damping BLQ 22 includes a Bp calculation unit 22A, a multiplier 22B, and a roll target damping force calculation unit 22C. The Bp calculation unit 22A obtains, based on Bᵣₒₗₗpᵣₒₗₗ obtained in advance and the roll GSPᵣ, the maximum value of Bᵣₒₗₗpᵣₒₗₗ corresponding to the roll rate. The multiplier 22B multiplies the maximum value of Bᵣₒₗₗpᵣₒₗₗ output from the Bp calculation unit 22A and the roll rate by each other. The roll target damping force calculation unit 22C multiplies a calculated value obtained by the multiplier 22B and an inverse matrix (Rᵣₒₗₗ⁻¹) of Rᵣₒₗₗ obtained in advance by each other, to thereby calculate the roll target damping force. In the manner described above, the roll damping BLQ 22 calculates a value obtained by multiplying a right side of Expression 20 given later by the relative speed from the left. As a result, the roll damping BLQ 22 calculates a roll target damping force obtained by multiplying a left side of Expression 20 given later by the roll rate from the left.

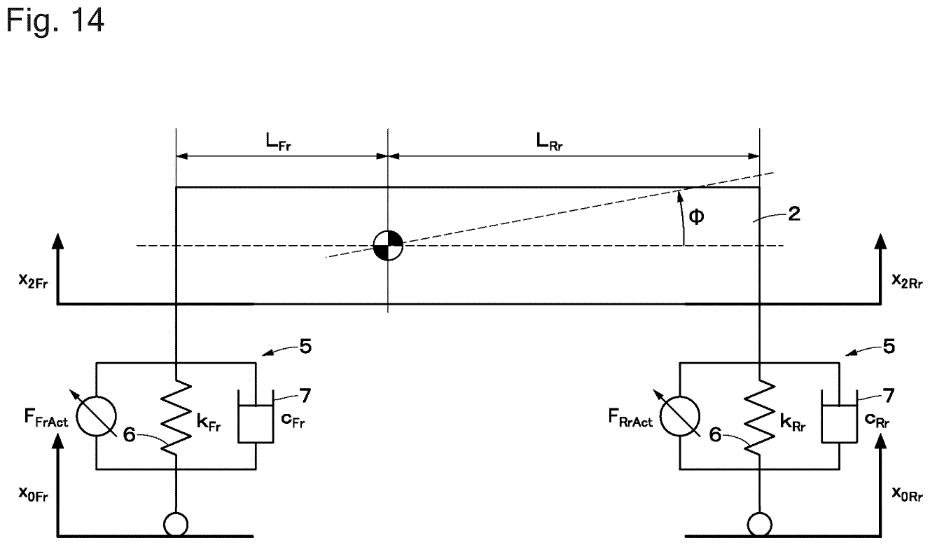

To the pitch damping BLQ 23, the vehicle state output from the state estimation unit 12 and the pitch GSPₚ output from the GSP calculation unit 13 are input. The pitch damping BLQ 23 calculates the pitch target damping force of the variable damper 7 for reducing pitch vibration based on the pitch rate and the pitch angle output from the state estimation unit 12 and the pitch GSPₚ output from the GSP calculation unit 13. The pitch damping BLQ 23 is designed based on, for example, a vehicle model illustrated in FIG. 14. In FIG. 14, a single-degree-of-freedom rotational motion model which is the simplest is exemplified as a vehicle model which considers the pitch. In an actual vehicle, a total of two sets of the motion models are respectively provided to the right side and the left side, and only one set thereof is schematically illustrated in FIG. 14. The pitch damping BLQ 23 is designed based on a state equation for the vehicle model of FIG. 14 as indicated in the design method described later.

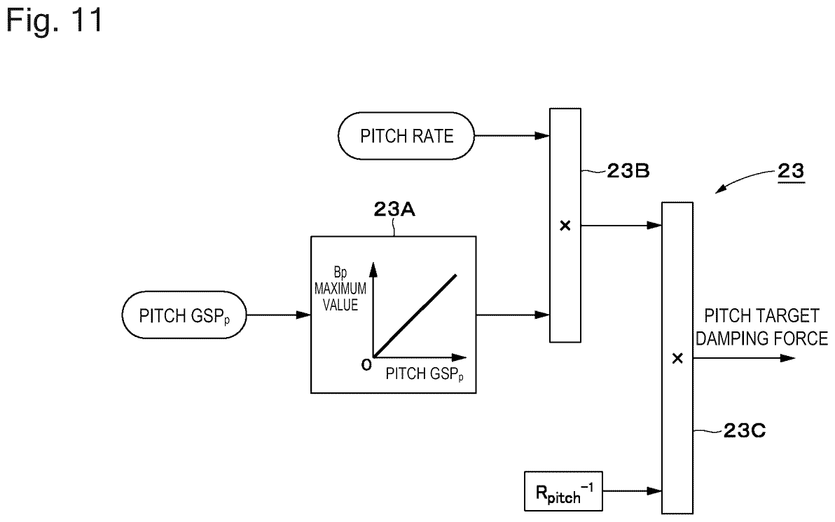

As illustrated in FIG. 11, the pitch damping BLQ 23 includes a Bp calculation unit 23A, a multiplier 23B, and a pitch target damping force calculation unit 23C. The Bp calculation unit 23A obtains, based on B_{pitch}p_{pitch} obtained in advance and the pitch GSPₚ, the maximum value of B_{pitch}p_{pitch} corresponding to the pitch rate. The multiplier 23B multiplies the maximum value of B_{pitch}p_{pitch} Output from the Bp calculation unit 23A and the pitch rate by each other. The pitch target damping force calculation unit 23C multiplies a calculated value obtained by the multiplier 23B and an inverse matrix (R_{pitch}⁻¹) of R_{pitch} obtained in advance by each other, to thereby calculate the pitch target damping force. In the manner described above, the pitch damping BLQ 23 calculates a value obtained by multiplying a right side of Expression 27 given later by the relative speed from the left. As a result, the pitch damping BLQ 23 calculates a pitch target damping force obtained by multiplying a left side of Expression 27 given later by the pitch rate from the left.

The target damping force calculation unit 24 calculates the actual target damping force for each variable damper 7 based on the three target damping forces (heave target damping force, roll target damping force, and pitch target damping force) output from the sprung vertical damping BLQ 21, the roll damping BLQ 22, and the pitch damping BLQ 23, respectively (see FIG. 5). The sprung vertical damping BLQ 21, the pitch damping BLQ 23, and the target damping force calculation unit 24 form an actual target damping force calculation unit which calculates the actual target damping force based on the heave GSP, the roll GSPᵣ, and the pitch GSPₚ (weight coefficients) obtained by the GSP calculation unit 13 (weight coefficient calculation unit) and the calculation result of the state estimation unit 12 (vertical motion calculation unit and pitch motion calculation unit).

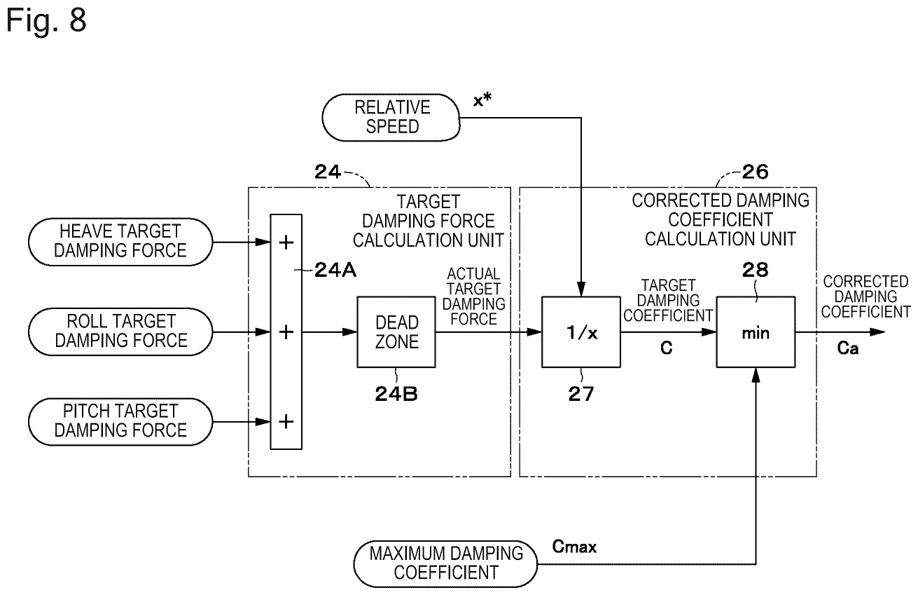

As illustrated in FIG. 8, the target damping force calculation unit 24 includes an adder 24A and a damping force dead zone calculation unit 24B. The adder 24A adds the heave target damping force from the sprung vertical damping BLQ 21, the roll target damping force from the roll damping BLQ 22, and the pitch target damping force from the pitch damping BLQ 23 to one another, to thereby calculate a BLQ target damping force obtained by summing those forces.

The damping force dead zone calculation unit 24B sets a dead zone for the BLQ target damping force output from the adder 24A. The damping force dead zone calculation unit 24B outputs the actual target damping force obtained by setting the dead zone for the BLQ target damping force.

In the bilinear optimal control (BLQ), the control acts for even minute road surface input, and hence there is a fear that a high damping force may be generated for the minute road surface input, resulting in deterioration of ride comfort. Thus, the damping force dead zone calculation unit 24B sets the dead zone for the BLQ target damping force. As a result, the damping force dead zone calculation unit 24B avoids the application of the control to the minute target damping force.

When a control gain of the BLQ changes in accordance with the vehicle speed, the dead zone is similarly set in accordance with the vehicle speed also in the dead zone selection processing. When a control gain of the BLQ varies also in accordance with a car mode, the dead zone is similarly set in accordance with the car mode also in the dead zone selection processing.

When each of the sprung speed and the relative displacement crosses 0 at the time of undulated road travel, the target damping force becomes small. When the damping force dead zone is set at this time, a control amount is not output, resulting in degradation in damping performance. Thus, in order to prioritize the damping performance at the time of undulated road travel, relaxation processing of reducing the dead zone is applied to a preliminary BLQ damping force dead zone so that the control amount is output even for a small target damping force when an undulated road index is high. Moreover, in order to increase a tuning property, the dead zone relaxation processing may be switched between an enabled state and a disabled state.

The target damping force calculation unit 24 adds the heave target damping force, the roll target damping force, and the pitch target damping force to one another, but the present invention is not limited to this example. The target damping force calculation unit 24 may, for example, select the maximum value of the heave target damping force, the roll target damping force, and the pitch target damping force.

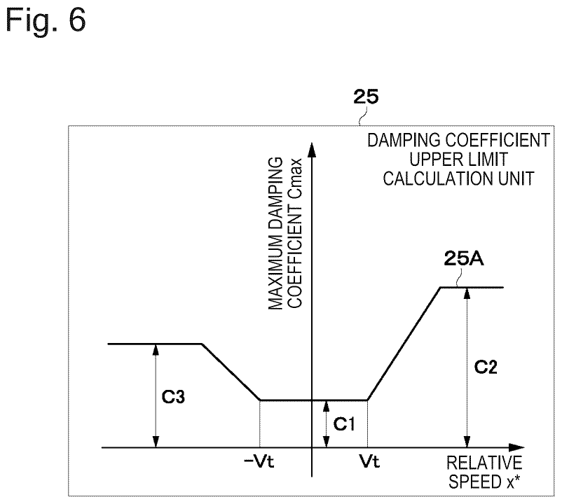

The damping coefficient upper limit calculation unit 25 calculates a maximum damping coefficient Cmax being an upper limit value of a damping coefficient C. As shown in FIG. 6, the damping coefficient upper limit calculation unit 25 is a maximum damping coefficient map which calculates the maximum damping coefficient Cmax based on the vehicle state. The damping coefficient upper limit calculation unit 25 includes, for example, a characteristic line 25A indicating a relationship between a relative speed x* between the sprung part and the unsprung part and the maximum damping coefficient Cmax. The damping coefficient upper limit calculation unit 25 outputs the maximum damping coefficient Cmax based on the relative speed x*. At this time, the maximum damping coefficient Cmax is set to a value within a range which does not exceed the maximum value of the damping coefficient which can be generated by the variable damper 7. The maximum damping coefficient Cmax is set to a small value when the relative speed x* is lower than a predetermined threshold value Vt, and set to a large value when the relative speed x* is higher than the threshold value Vt.

Specifically, when the relative speed x* is lower than the threshold value Vt (−Vt<x*<Vt), the maximum damping coefficient Cmax is set to a low-speed set value C1 having a small value. Meanwhile, when the relative speed x* on an extension side (positive side) is higher than the threshold value Vt (x*>Vt), the maximum damping coefficient Cmax is set to a high-speed set value C2 larger in value than the low-speed set value C1. Similarly, when the relative speed x* on a compression side (negative side) is higher than the threshold value Vt (x*<−Vt), the maximum damping coefficient Cmax is set to a high-speed set value C3 larger in value than the low-speed set value C1.

When the relative speed x* becomes a value close to the threshold value Vt, the maximum damping coefficient Cmax may be set to a value between the low-speed set value C1 and the high-speed set value C2. Similarly, when the relative speed x* becomes a value close to the threshold value (−Vt), the maximum damping coefficient Cmax may be set to a value between the low-speed set value C1 and the high-speed set value C3.

The high-speed set values C2 and C3 are appropriately set in consideration of the structure, specifications, the damping force characteristic, and the like of the variable damper 7. Moreover, the case in which each of the low-speed set value C1 and the high-speed set values C2 and C3 is the constant value has been exemplified, but the set values may change in accordance with the relative speed x*.

The threshold value Vt is experimentally obtained in consideration of, for example, occurrence situation of jerk, and is appropriately set in accordance with the structure, the damping force characteristic, and the like of the variable damper 7. Moreover, the threshold value Vt may be set to the same value on the positive side and the negative side of the relative speed x*, or may be set to values different from each other between the positive side and the negative side of the relative speed x*.

The corrected damping coefficient calculation unit 26 calculates a target damping coefficient C corresponding to the actual target damping force, and outputs a corrected damping coefficient Ca based on this target damping coefficient C and the maximum damping coefficient Cmax (see FIG. 8). The corrected damping coefficient calculation unit 26 includes a target damping coefficient calculation unit 27 and a minimum value selection unit 28.

The target damping coefficient calculation unit 27 forms a target damping coefficient calculation unit which calculates the target damping coefficient C based on the calculated value of the actual target damping force calculation unit. The target damping coefficient calculation unit 27 calculates the target damping coefficient C corresponding to the actual target damping force output from the target damping force calculation unit 24. Specifically, the target damping coefficient calculation unit 27 is formed of a divider, and divides the relative speed x* from the actual target damping force, to thereby calculate the target damping coefficient C.

The minimum value selection unit 28 compares the target damping coefficient C output from the target damping coefficient calculation unit 27 and the maximum damping coefficient Cmax output from the damping coefficient upper limit calculation unit 25 with each other, selects a smaller value of those coefficients C and Cmax, and outputs the selected value as the corrected damping coefficient Ca. Thus, the minimum value selection unit 28 and the damping coefficient upper limit calculation unit 25 form a correction unit which calculates the corrected damping coefficient Ca obtained by reducing the upper limit of the target damping coefficient C in a region in which the relative speed x* between the sprung part and the unsprung part of the vehicle is low.

In this configuration, the correction unit sets the corrected damping coefficient Caso that the damping force increases in accordance with an increase in the relative speed x*, a gradient of the damping force with respect to the relative speed x* is small when the relative speed x* is low, and the gradient of the damping force with respect to the relative speed x* is large when the relative speed x* is high. In addition thereto, the correction unit has the maximum damping coefficient Cmax corresponding to the relative speed x*, and corrects the target damping coefficient C to the maximum damping coefficient Cmax when the target damping coefficient C exceeds the maximum damping coefficient Cmax.

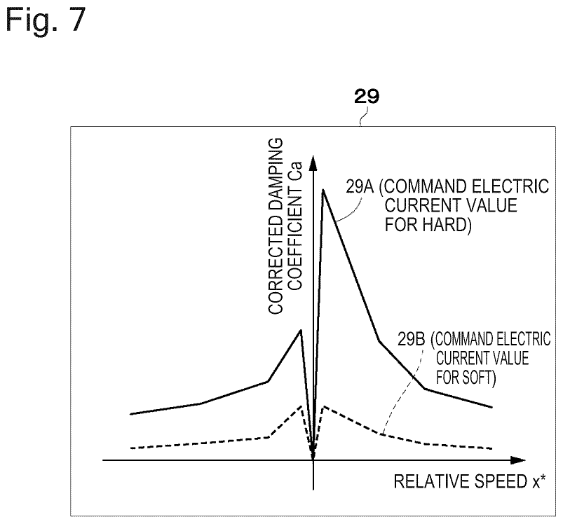

The command value calculation unit 29 forms a control signal output unit which outputs, to the variable damper 7 (damping-force adjustable shock absorber), a control signal corresponding to the corrected damping coefficient Ca. The command value calculation unit 29 outputs a command electric current value I as the control signal corresponding to the corrected damping coefficient Ca. As shown in FIG. 7, the command value calculation unit 29 is a damping coefficient map which variably sets a relationship between the corrected damping coefficient Ca and the command electric current value I in accordance with the relative speed x*. This damping coefficient map is generated based on test data obtained by the inventors and others. Moreover, the command value calculation unit 29 identifies the command electric current value I for adjusting the damping force characteristic of the variable damper 7 based on the corrected damping coefficient Ca and the relative speed x*, and outputs this command electric current value I to the damping force variable actuator 8 of the variable damper 7.

Moreover, the command value calculation unit 29 outputs the control signal (command electric current value I) for controlling the variable damper 7 such that, for example, the damping-force adjustable shock absorber conforms to the skyhook theory. This command value calculation unit 29 includes a characteristic line 29A on a hard side indicated by the solid line of FIG. 7 and a characteristic line 29B on a soft side indicated by the broken line of FIG. 7. In this configuration, the characteristic line 29A on the hard side is arranged in a range larger in the corrected damping coefficient Ca than the characteristic line 29B on the soft side.

Moreover, when the relative speed x* and the corrected damping coefficient Ca are input, an intersection between the corrected damping coefficient Ca and the relative speed x* is obtained in the damping coefficient map of the command value calculation unit 29. When this intersection is arranged in a range in which the corrected damping coefficient Ca is larger than the characteristic line 29A on the hard side, the command electric current value I is increased, to thereby set the damping force characteristic to the hard characteristic. Meanwhile, when this intersection is arranged in a range in which the corrected damping coefficient Ca is smaller than the characteristic line 29B on the soft side, the command electric current value I is reduced, to thereby set the damping force characteristic to the soft characteristic. Further, when the intersection is arranged in a range between the characteristic line 29A on the hard side and the characteristic line 29B on the soft side, the command electric current value I is adjusted in accordance with the corrected damping coefficient Ca, to thereby set the damping force characteristic to an intermediate characteristic between the hard characteristic and the soft characteristic.

As a result, the generated damping force of the variable damper 7 is variably adjusted continuously, or at a plurality of steps, between the hard characteristic and the soft characteristic in accordance with the command electric current value I supplied to the damping force variable actuator 8.

Description is now given of the design method for the sprung vertical damping BLQ 21, the roll damping BLQ 22, and the pitch damping BLQ 23, and description is also given of tuning thereof through use of gain scheduling parameters (GSPs).

### (1) Design for Vertical Motion Control System (Sprung Vertical Damping BLQ 21)

The control design model (¼ vehicle model) intended for a vertical motion is illustrated in FIG. 12. Here, an absolute vertical displacement of the vehicle body 2 (sprung part) is represented by z_{b}, an absolute vertical displacement of the unsprung part is represented by zₜ, an absolute vertical displacement of the road surface is represented by z₀, a sprung mass (vehicle body mass) is represented by m_{b}, an unsprung mass is represented by mₜ, a spring constant between the vehicle body 2 and the unsprung part (inter-sprung part-unsprung part) is represented by kₛ, a tire spring constant is represented by kₜ, a damper damping coefficient is represented by “c,” and a control force acting between the sprung part and the unsprung part is represented by “f.” Moreover, it is considered that the control force “f” is applied in addition to the soft damping force characteristic, and hence a damping coefficient for the soft damping force characteristic is set as the damper damping coefficient c.

At this time, when a relative displacement between the sprung part and the unsprung part is represented by z_{bt}, and a relative displacement between the unsprung part and the road surface is represented by zₜ₀, the relative displacements z_{bt} and zₜ₀ and a state equation are as given by Expression 1 to Expression 3. In the state equation, a state variable “x” and an output “y” are as given by Expression 4 and Expression 5. Each of dots in the expression means a first derivative (d/dt) with respect to the time “t”. When the number of dots is two, the two dots mean a second derivative (d²/dt²).

z_{bt}=z_{b}−zₜ [Expression 1]

zₜ₀=zₜ−z₀ [Expression 2]

\dot{x}=Ax+Bu+Gw

y=Cx+Du [Expression 3]

x=[z_{bt}ż_{b}zₜ₀żₜ] [Expression 4]

y=[\ddot{z}_{b} \ddot{z}ₜ ż_{b}−żₜ z_{bt} ż_{b} zₜ₀ żₜ] [Expression 5]

An external force “u” acting between the vehicle body 2 and the unsprung part is considered as the control force “f” (u=f), and a disturbance “w” is considered as the detected road surface displacement z₀ (w=z₀). Moreover, each of the elements of the state equation is as given by Expression 6.

$$[ Expression 6 ]$$

$$A = [ \begin{matrix}0 & 1 & 0 & - 1 \\ - \frac{{k}_{s}}{{m}_{b}} & - \frac{c}{{m}_{b}} & 0 & \frac{c}{{m}_{b}} \\ 0 & 0 & 0 & 1 \\ \frac{{k}_{s}}{{m}_{t}} & \frac{c}{{m}_{t}} & - \frac{{k}_{t}}{{m}_{t}} & - \frac{c}{{m}_{t}}\end{matrix} ] , B = [ \begin{matrix}0 \\ \frac{1}{{m}_{b}} \\ 0 \\ - \frac{1}{{m}_{t}}\end{matrix} ] , G = [ \begin{matrix}0 \\ 0 \\ - 1 \\ 0\end{matrix} ] ,$$

$$C = [ \begin{matrix}- \frac{{k}_{s}}{{m}_{b}} & - \frac{c}{{m}_{b}} & 0 & \frac{c}{{m}_{b}} \\ \frac{{k}_{s}}{{m}_{t}} & \frac{c}{{m}_{t}} & - \frac{{k}_{t}}{{m}_{t}} & - \frac{c}{{m}_{t}} \\ 0 & 1 & 0 & - 1 \\ 1 & 0 & 0 & 0 \\ 0 & 1 & 0 & 0 \\ 0 & 0 & 1 & 0 \\ 0 & 0 & 0 & 1\end{matrix} ] , D = [ \begin{matrix}\frac{1}{{m}_{b}} \\ - \frac{1}{{m}_{t}} \\ 0 \\ 0 \\ 0 \\ 0 \\ 0\end{matrix} ]$$

Description is now given of the design method for the vertical motion control system (sprung vertical damping BLQ 21) based on the bilinear optimal control theory in consideration of the above-mentioned state equation. In the above-mentioned state equation, the control force “f” is used, but the input is treated as a damping coefficient us in the case of the bilinear system. Thus, Expression 3 is described by a state equation as given below.

\dot{x}=Ax+Bx*u_{c}+Gw [Expression 7]

Here, x* is a matrix including the state variable “x”, and hence the control force “f” expressed by the damping coefficient input u_{c} and the relative speed is given by Expression 8. In this expression, x* is as given by Expression 9.

f=−u_{c}(ż_{b}−żₜ) [Expression 8]

x*=(ż_{b}−żₜ) [Expression 9]

When the input is irregular, the state variable is generally a stochastic variable, and hence Expression 10 represented by an expected value is used as an evaluation function. However, the state quantities (inter-sprung-part-unsprung-part relative displacement, sprung speed, inter-unsprung part-road surface relative displacement, and unsprung speed) are used for the evaluation function. Moreover, C^{T}QC is a weight matrix for the output, and R is a weight matrix for the input.

$$[ Expression 10 ]$$

$$J ( {u}_{c} ) = E \{ {\int }_{{t}^{0}}^{t} [ {x}^{T} {C}^{T} QCx + {u}_{c} {x}^{* T} {Rxu}_{c} ] dt \}$$

Here, an optimal control input u_{c}⁰ which satisfies Expression 11 is to be obtained. When the above-mentioned problem is solved through the dynamic programming, and the optimal control input u_{c}⁰ is considered as a steady problem, the optimal control input u_{c}⁰ is obtained as given by Expression 12.

$$J ( {u}_{c}^{0} ) = {min}_{{u}_{c}} J ( {u}_{c} ) \qquad [ Expression 11 ]$$

$${u}_{c}^{o} = - {( {x}^{* T} R )}^{- 1} {B}^{T} px \qquad [ Expression 12 ]$$

Symbol “p” of Expression 12 is a unique positive definite solution of Expression 13.

0=A^{T}p+pA−pBR⁻¹B^{T}p+C^{T}QC [Expression 13]

Here, values given by Expression 14 are set as Q and R of the sprung vertical damping BLQ 21, to thereby calculate “p”.

$$Q = [ \begin{matrix}38 & 0 & 0 & 0 & 0 & 0 & 0 \\ 0 & 0.25 & 0 & 0 & 0 & 0 & 0 \\ 0 & 0 & 64 & 0 & 0 & 0 & 0 \\ 0 & 0 & 0 & 112.01 & 0 & 0 & 0 \\ 0 & 0 & 0 & 0 & 277640.01 & 0 & 0 \\ 0 & 0 & 0 & 0 & 0 & 96.5 & 0 \\ 0 & 0 & 0 & 0 & 0 & 0 & 100\end{matrix} ] , \qquad [ Expression 14 ]$$

$$R = 0.005$$

### (2) Design for Roll Motion Control System (Roll Damping BLQ 22)

In the same manner as in the above-mentioned control system for the vertical motion, the roll damping BLQ 22 based on the bilinear control theory is designed. A motion model is the single-degree-of-freedom rotational motion model illustrated in FIG. 13 which is the simplest as a vehicle model in consideration of the roll.

Here, the roll angle of the vehicle body is represented by 0, absolute vertical displacements of the left and right wheels on the road surface are represented by x₀ₗ and x₀ᵣ, respectively, a vehicle body roll inertia is represented by I, the spring constant between the sprung part and the unsprung part is represented by kₛ, the spring constant of a stabilizer is represented by kₛₜ, the damper damping coefficient is represented by “c”, and external forces acting between the sprung part and the unsprung part at the right and left wheels are represented by Fᵣ and Fₗ, respectively. From FIG. 13, the motion equation in the roll direction is derived as given by Expression 15.

$$I \ddot{θ} = - \frac{{cL}^{2}}{2} \dot{θ} - \frac{( {k}_{s} + {k}_{st} ) {L}^{2}}{2} θ - {F}_{r} \frac{L}{2} + {F}_{1} \frac{L}{2} + \frac{cL}{2} ( {\dot{x}}_{0 l} + {\dot{x}}_{0 r} ) + \frac{( {k}_{s} + {k}_{st} ) L}{2} ( {x}_{0 l} + {x}_{0 r} ) \qquad [ Expression 15 ]$$

This is the case of the bilinear system, and hence a state equation is given by Expression 16.

$${\dot{x}}_{roll} = {A}_{roll} {x}_{roll} + {B}_{roll} {x}_{roll}^{*} {u}_{croll} + {G}_{roll} {w}_{roll} \qquad [ Expression 16 ]$$

$${y}_{roll} = {C}_{roll} {x}_{roll}$$

Here, this is the case of the bilinear system, and hence the external forces represented by damping coefficient inputs cᵣ and cₗ and the relative speeds of the right and left wheels are given by Expression 17.

Fᵣ=cᵣ(L\dot{θ}−\dot{x}ᵣ)

Fₗ=cₗ(L\dot{θ}−\dot{x}ₗ) [Expression 17]

Moreover, state variables xᵣₒₗₗ and x*ᵣₒₗₗ, a control force u_{croll}, and a disturbance wᵣₒₗₗ are given by Expression 18.

$${x}_{roll} = {[ \begin{matrix}\dot{θ} & θ\end{matrix} ]}^{T} , {x}_{roll}^{*} = [ \begin{matrix}L \dot{θ} - {\dot{x}}_{r} & O \\ O & - L \dot{θ} - {\dot{x}}_{l}\end{matrix} ] , \qquad [ Expression 18 ]$$

$${u}_{croll} = {[ \begin{matrix}{c}_{r} & {c}_{l}\end{matrix} ]}^{T} , {w}_{roll} = {[ {\dot{x}}_{l} - \begin{matrix}{\dot{x}}_{r} & {x}_{l} - {x}_{r}\end{matrix} ]}^{T}$$

At this time, each of the elements of the state equation is as given by Expression 19.

$${A}_{roll} = [ \begin{matrix}\frac{- {cL}^{2}}{2 I} & \frac{- ( {k}_{s} + {k}_{st} ) {L}^{2}}{2 I} \\ 1 & 0\end{matrix} ] , {B}_{roll} = [ \begin{matrix}\frac{- L}{2 I} & \frac{L}{2 I} \\ 0 & 0\end{matrix} ] , \qquad [ Expression 19 ]$$

$${G}_{roll} = [ \begin{matrix}\frac{cL}{2 I} & \frac{( {k}_{s} + {k}_{st} ) L}{2 I} \\ 0 & 0\end{matrix} ] , {C}_{roll} = [ \begin{matrix}1 & 0 \\ 0 & 1\end{matrix} ]$$

An optimal control input u⁰_{croll} obtained from this state equation in the same manner as in the control in the control system for the vertical vibration is given by Expression 20.

$${u}_{croll}^{0} = - {( {x}_{roll}^{* T} {R}_{roll} )}^{- 1} {B}_{roll}^{T} {p}_{roll} {x}_{roll} \qquad [ Expression 20 ]$$

Symbol pᵣₒₗₗ of Expression 20 is a unique positive definite solution of Expression 21.

0=Aᵣₒₗₗ^{T}pᵣₒₗₗ+pᵣₒₗₗAᵣₒₗₗ−pᵣₒₗₗBᵣₒₗₗRᵣₒₗₗ⁻¹Bᵣₒₗₗpᵣₒₗₗ+Cᵣₒₗₗ^{T}QᵣₒₗₗCᵣₒₗₗ [Expression 21]

Here, values given by Expression 22 are set as Qᵣₒₗₗ and Rᵣₒₗₗ of the roll damping BLQ 22, to thereby calculate pᵣₒₗₗ.

$${Q}_{roll} = [ \begin{matrix}8000000 & 0 \\ 0 & 5\end{matrix} ] , {R}_{roll} = [ \begin{matrix}0.2 & 0 \\ 0 & 0.2\end{matrix} ] \qquad [ Expression 22 ]$$

### (3) Design for Pitch Motion Control System (Pitch Damping BLQ 23)

In the same manner as in the above-mentioned control system for the vertical motion and the roll motion, the pitch damping BLQ 23 based on the bilinear control theory is designed. A motion model is the single-degree-of-freedom rotational motion model illustrated in FIG. 14 which is the simplest as a vehicle model in consideration of the pitch.

Here, vertical forces applied from the front and rear suspensions to the vehicle body are represented by F_{Fr} and F_{Rr}, respectively, front and rear spring constants are represented by k_{Fr} and k_{Rr}, respectively, front and rear damping coefficients are represented by c_{Fr} and c_{Rr}, respectively, horizontal-direction distances from the center of gravity to the front and rear suspensions are represented by L_{Fr} and L_{Rr}, respectively, a pitch angle is represented by Φ, front and rear vehicle height displacements are represented by x_{2Fr} and x_{2Rr}, respectively, front and rear road surface heights are represented by x_{0Fr} and x_{0Rr}, respectively, vertical forces generated by the front and rear actuators are represented by F_{FrAct} and F_{RrAct}, respectively, and a pitch-direction sprung moment of inertia about the ½ center of gravity is represented by I_{yy}. From FIG. 14, the motion equation in the roll direction is derived as given by Expression 23.

$$\ddot{ϕ} = - \frac{2 {L}_{Fr}^{2} {c}_{Fr} + 2 {L}_{Rr}^{2} {c}_{Rr}}{{I}_{yy}} \dot{ϕ} - \frac{{L}_{Fr}^{2} {k}_{Fr} + {L}_{Rr}^{2} {k}_{Rr}}{{I}_{yy}} ϕ - \frac{2 {L}_{Fr} {\dot{x}}_{0 Fr}}{{I}_{yy}} {c}_{Fr} + \frac{2 {L}_{Rr} {x}_{0 Rr}}{{I}_{yy}} {c}_{Rr} - \frac{{L}_{Fr} {k}_{Fr}}{{I}_{yy}} {x}_{0 Fr} + \frac{{L}_{Rr} {k}_{Rr}}{{I}_{yy}} {x}_{0 Rr} \qquad [ Expression 23 ]$$

Here, this is the case of the bilinear system, and hence a state equation is given by Expression 24.

$${\dot{x}}_{pitch} = {A}_{pitch} {x}_{pitch} + {B}_{pitch} {x}_{pitch}^{*} {u}_{cpitch} + {G}_{pitch} {w}_{pitch} \qquad [ Expression 24 ]$$

Moreover, state variables x_{pitch} and x*_{pitch}, a control force u_{cpitch}, and a disturbance w_{pitch} are given by Expression 25.

$${x}_{pitch} = {[ \begin{matrix}\dot{ϕ} & ϕ\end{matrix} ]}^{T} , {x}_{pitch}^{*} = [ \begin{matrix}{\dot{x}}_{0 Fr} & O \\ O & {\dot{x}}_{0 Rr}\end{matrix} ] , \qquad [ Expression 25 ]$$

$${u}_{cpitch} = {[ \begin{matrix}{c}_{Fr} & {c}_{Rr}\end{matrix} ]}^{T} , {w}_{pitch} = {[ \begin{matrix}{x}_{0 Fr} & {x}_{0 Rr}\end{matrix} ]}^{T}$$

At this time, each of the elements of the state equation is as given by Expression 26.

$${A}_{pitch} = [ \begin{matrix}- \frac{2 {L}_{Fr}^{2} {c}_{Fr} + 2 {L}_{Rr}^{2} {c}_{Rr}}{{I}_{yy}} & - \frac{{L}_{Fr}^{2} {k}_{Fr} + {L}_{Rr}^{2} {k}_{Rr}}{{I}_{yy}} \\ 1 & 0\end{matrix} ] , \qquad [ Expression 26 ]$$

$${B}_{pitch} = [ \begin{matrix}- \frac{2 {L}_{Fr}}{{I}_{yy}} & \frac{2 {L}_{Rr}}{{I}_{yy}} \\ 0 & 0\end{matrix} ] , {G}_{pitch} = [ \begin{matrix}- \frac{{L}_{Fr} {k}_{Fr}}{{I}_{yy}} & \frac{{L}_{Rr} {k}_{Rr}}{{I}_{yy}} \\ 0 & 0\end{matrix} ]$$

An optimal control input u⁰_{cpitch} obtained from this state equation in the same manner as in the control in the control system for the vertical vibration is given by Expression 27.

$${u}_{cpitch}^{0} = - {( {x}_{pitch}^{* T} {R}_{pitch} )}^{- 1} {B}_{pitch}^{T} {p}_{pitch} {x}_{pitch} \qquad [ Expression 27 ]$$

Symbol p_{pitch} of Expression 27 is a unique positive definite solution of Expression 28.

[Expression 28]

0=A_{pitch}^{T}p_{pitch}+p_{pitch}A_{pitch}−p_{pitch}B_{pitch}R_{pitch}⁻¹B_{pitch}^{T}p_{pitch}+C_{pitch}^{T}Q_{pitch}C_{pitch}

Here, values given by Expression 29 are set as Q_{pitch} and R_{pitch} of the pitch damping BLQ 23, to thereby calculate p_{pitch}.

$${Q}_{pitch} = [ \begin{matrix}8 \times {10}^{8} & 0 \\ 0 & 0\end{matrix} ] , {R}_{pitch} = [ \begin{matrix}1 & 0 \\ 0 & 1\end{matrix} ] \qquad [ Expression 29 ]$$

### (4) Tuning Through Use of Gain Scheduling Parameters

The optimal control input to the control systems for the vertical vibration, the roll vibration, and the pitch vibration are given by Expression 11, Expression 20, and Expression 27, respectively. In this configuration, theoretical maximum values (control amount maximum values) and minimum values (control amount minimum values) of B^{T}p, Bᵣₒₗₗ^{T}pᵣₒₗₗ, and B_{pitch}^{T}p_{pitch} are obtained in advance through calculation. For example, an example of the maximum values and the minimum values of Bᵣₒₗₗ^{T}pᵣₒₗₗ and B_{pitch}^{T}p_{pitch} is described below. B^{T}p can also be similarly obtained in advance through calculation.

$$Control amount maximum : {B}_{roll}^{T} {p}_{roll} = [ \begin{matrix}- 625.7 & 0 \\ 625.7 & 0\end{matrix} ] \qquad [ Expression 30 ]$$

$$Control amount minimum : {B}_{roll}^{T} {p}_{roll} = [ \begin{matrix}0 & 0 \\ 0 & 0\end{matrix} ]$$

$$Control amount maximum : {B}_{pitch}^{T} {p}_{pitch} = [ \begin{matrix}- 14280 & - 0.008 \\ 21866 & 0.0013\end{matrix} ] \qquad [ Expression 31 ]$$

$$Control amount minimum : {B}_{pitch}^{T} {p}_{pitch} = [ \begin{matrix}0 & 0 \\ 0 & 0\end{matrix} ]$$

A value between the maximum value and the longest value is linearly interpolated through use of the parameters (heave GSP, roll GSPᵣ, or pitch GSPₚ), to thereby select any control amount. The target damping forces for the vertical damping, the roll damping, and the pitch damping can be obtained based on the control amounts obtained through use of the heave GSP, the roll GSPᵣ, and the pitch GSPₚ and Expression 11, Expression 20, and Expression 27, respectively.

When the BLQ is to be tuned without using the gain scheduling parameters, it is required to change Q, R, Qᵣₒₗₗ, Rᵣₒₗₗ, Q_{pitch}, and R_{pitch} and then solve again a Riccati equation each time. In contrast, when the BLQ is to be tuned through use of the gain scheduling parameters (heave GSP, roll GSPᵣ, and pitch GSPₚ), it is not required to solve again the Riccati equation. Thus, it is possible to tune the BLQ through use of small man-hours.

The vehicle behavior control device 1 in the first embodiment has the above-mentioned configuration. Description is now given of processing of variably controlling the damping force characteristic of the variable damper 7 through use of the controller 11.

To the controller 11, specifications relating to the travel of the vehicle are input through the CAN 9 at the time of travel of the vehicle. The state estimation unit 12 of the controller 11 estimates, based on the CAN signal, the inter-sprung part-unsprung part relative speed, the vehicle body absolute vertical speed (sprung speed), the inter-unsprung part-road surface relative speed, the unsprung absolute vertical speed (unsprung speed), the roll rate, the roll angle, the pitch rate, the pitch angle, and the like being the vehicle state.

At this time, to the BLQ controller 20 of the controller 11, the vehicle state calculated by the state estimation unit 12 and the heave GSP, the roll GSPᵣ, and the pitch GSPₚ calculated by the GSP calculation unit 13 are input. The sprung vertical damping BLQ 21 of the BLQ controller 20 calculates the heave target damping force based on the vehicle state and the heave GSP. The roll damping BLQ 22 of the BLQ controller 20 calculates the roll target damping force based on the vehicle state and the roll GSPᵣ. The pitch damping BLQ 23 of the BLQ controller 20 calculates the heave target damping force based on the vehicle state and the pitch GSPₚ.

The target damping force calculation unit 24 of the BLQ controller 20 calculates the actual target damping force based on the heave target damping force, the roll target damping force, and the pitch target damping force. The target damping coefficient calculation unit 27 of the BLQ controller 20 divides the relative speed x* from the actual target damping force, to thereby calculate the target damping coefficient C. The minimum value selection unit 28 of the BLQ controller 20 selects a smaller one of the target damping coefficient C output from the target damping coefficient calculation unit 27 and the maximum damping coefficient Cmax output from the damping coefficient upper limit calculation unit 25, and outputs the selected value as the corrected damping coefficient Ca. The command value calculation unit 29 of the BLQ controller 20 calculates the command electric current value I corresponding to the corrected damping coefficient Ca and the relative speed x*.

After that, the command electric current value I is input to the damping force variable actuator 8 of the variable damper 7, to thereby control the drive of the damping force variable actuator 8. As a result, the damping force characteristic of the variable damper 7 becomes variable between the hard characteristic and the soft characteristic, and is continuously controlled.

In particular, the controller 11 according to the first embodiment includes the pitch damping BLQ 23, and calculates the command electric current value I based on the pitch target damping force calculated by the pitch damping BLQ 23. Thus, as compared with a case in which the pitch damping BLQ 23 is omitted, the pitch vibration can be suppressed more.

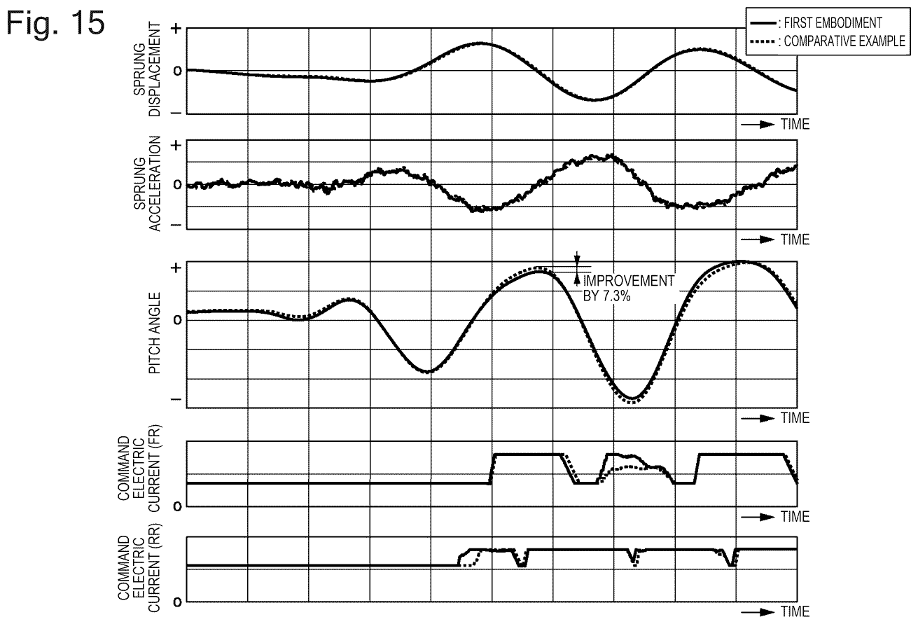

In order to confirm the above-mentioned effect of the improvement of the pitch vibration achieved by this embodiment, an actual vehicle test in a case of travel on an undulated road was executed for the first embodiment and a comparative example. Results obtained at this time are shown in FIG. 15. In the actual vehicle test, the vehicle speed was 100 km/h, the heave GSP was 0.6, and the pitch GSPₚ was 0.3.

In FIG. 15, the solid lines indicate characteristics in the first embodiment. The controller 11 at this time sets the gain of the roll target damping force to 0 when the roll target damping force is to be calculated. That is, the solid lines of FIG. 15 indicate characteristics exhibited when the roll damping BLQ 22 is omitted from the controller 11 according to the first embodiment. Meanwhile, the broken lines of FIG. 15 indicate characteristics in the comparative example (related art). At this time, the comparative example corresponds to a case in which the controller of Patent Literature 1 is used. That is, in the comparative example, the variable damper 7 is controlled based on a target damping force which suppresses only the sprung vertical vibration. As shown in FIG. 15, in the first embodiment, an amplitude of the pitch angle is reduced more as compared with the comparative example, and it is understood that, for example, the pitch vibration is improved (reduced) by approximately 7.3%.

As described above, the controller 11 serving as the control device according to this embodiment includes: the weight coefficient calculation unit (GSP calculation unit 13) which calculates the weight coefficients (heave GSP and pitch GSPₚ) for causing the actual target damping force based on the calculated values of the vehicle behavior calculation unit (state estimation unit 12) to approach a value close to the target damping force obtained in advance; the vertical motion calculation unit (state estimation unit 12) which obtains the state relating to the motion of the vehicle in the vertical direction; the pitch motion calculation unit (state estimation unit 12) which obtains the state relating to the motion of the vehicle in the pitch direction; the actual target damping force calculation unit (sprung vertical damping BLQ 21, pitch damping BLQ 23, and target damping force calculation unit 24) which calculates the actual target damping force based on the weight coefficients calculated by the weight coefficient calculation unit and the calculation results of the vertical motion calculation unit and the pitch motion calculation unit; the target damping coefficient calculation unit (target damping coefficient calculation unit 27) which calculates the target damping coefficient based on the calculated values of the actual target damping force calculation unit; the correction unit (minimum value selection unit 28) which calculates the corrected damping coefficient Ca obtained by reducing the upper limit of the target damping coefficient C in the region in which the relative speed x* between the sprung part and the unsprung part of the vehicle is low; and the control signal output unit (command value calculation unit 29) which outputs the control signal corresponding to the corrected damping coefficient Ca to the damping-force adjustable shock absorber (variable damper 7).

In this configuration, the weight coefficient calculation unit (GSP calculation unit 13) calculates, as the weight coefficient, the heave GSP relating to the motion of the vehicle in the vertical direction and the pitch GSPₚ relating to the motion of the vehicle in the pitch direction. The actual target damping force calculation unit includes the heave BLQ (sprung vertical damping BLQ 21) which calculates the target damping force in the vertical direction of the vehicle based on the heave GSP and the calculation result of the vertical motion calculation unit, and the pitch BLQ (pitch damping BLQ 23) which calculates the target damping force in the pitch direction of the vehicle based on the pitch GSPₚ and the calculation result of the pitch motion calculation unit. The actual target damping force calculation unit calculates the actual target damping force based on the target damping force (heave target damping force) calculated by the heave BLQ and the target damping force (pitch target damping force) calculated by the pitch BLQ.

Thus, the controller 11 can control the damping force of the variable damper 7 based on the heave target damping force for suppressing the vertical vibration of the sprung part and the pitch target damping force for suppressing the pitch vibration. As a result, it is possible to reduce both of the vertical vibration and the pitch vibration of the sprung part. Moreover, the controller 11 calculates the actual target damping force based on the weight coefficients (heave GSP and pitch GSPₚ) and the vehicle state (the inter-sprung part-unsprung part relative speed, the vehicle body absolute vertical speed (sprung speed), the inter-unsprung part-road surface relative speed, the unsprung absolute vertical speed (unsprung speed), the pitch rate, and the pitch angle). Thus, it is not required to solve again the Riccati equation, and the weight coefficients (heave GSP and pitch GSPₚ) are adjusted to reduce the tuning parameters. As a result, it is possible to easily tune the controller 11 (sprung vertical damping BLQ 21 and pitch damping BLQ 23).

Further, the correction unit (minimum value selection unit 28) of the controller 11 sets the corrected damping coefficient Ca so that the damping force increases in accordance with an increase in the relative speed x*, the gradient of the damping force with respect to the relative speed x* is small when the relative speed x* is low, and the gradient of the damping force with respect to the relative speed is large when the relative speed x* is high. The correction unit has the maximum damping coefficient Cmax corresponding to the relative speed x*, and outputs the corrected damping coefficient Ca obtained by correcting the target damping coefficient C to the maximum damping coefficient Cmax when the target damping coefficient C exceeds the maximum damping coefficient Cmax.

Thus, when the relative speed x* is low as in a stroke inversion between an extension stroke and a compression stroke of the variable damper 7, the controller 11 outputs the corrected damping coefficient Ca obtained by reducing the upper limit of the target damping coefficient C, and outputs the command electric current value I corresponding to this corrected damping coefficient Ca to the variable damper 7. As a result, it is possible to reduce occurrence of noise and the jerk caused by a sudden change in damping force.

Meanwhile, the controller 11 calculates the corrected damping coefficient Ca obtained by increasing the upper limit of the target damping coefficient C when the relative speed x* is high as compared with that at the time when the relative speed x* is low. In this case, when the relative speed x* is high as those in the middle of the extension stoke and the compression stroke of the variable damper 7, it is possible to avoid the limit on the target damping coefficient C as much as possible, to thereby calculate the corrected damping coefficient Ca having a large value. As a result, when the relative speed x* is high, it is possible to secure the damping performance by generating a large damping force with the variable damper 7. Thus, the ride comfort can be increased.

The controller 11 further includes the posture change detection unit (state estimation unit 12) which detects the posture change in the vehicle body 2, and the correction unit (minimum value selection unit 28) reduces the correction amount when the correction unit determines, based on the detection result of the posture change detection unit, that the posture change occurs.

At this time, when the posture change in the vehicle body 2 does not occur, the correction unit increases a correction amount, to thereby reduce the upper limit of the target damping coefficient when the relative speed is low. As a result, a sudden change in damping force can be suppressed. Meanwhile, when the posture change in the vehicle body occurs, the correction unit reduces the correction amount, to thereby relax the restriction on the upper limit of the target damping coefficient. As a result, it is possible to generate a damping force against the posture change in the vehicle body, and hence the damping performance can be secured.

The controller 11 further includes the roll motion calculation unit (state estimation unit 12) which obtains the state relating to the motion of the vehicle in the roll direction. In this case, the weight coefficient calculation unit (GSP calculation unit 13) calculates, as the weight coefficient, the heave GSP relating to the motion of the vehicle in the vertical direction, the roll GSP relating to the motion of the vehicle in the roll direction, and the pitch GSP relating to the motion of the vehicle in the pitch direction. The actual target damping force calculation unit includes the heave BLQ (sprung vertical damping BLQ 21) which calculates the target damping force in the vertical direction of the vehicle based on the heave GSP and the calculation result of the vertical motion calculation unit, the roll BLQ (roll damping BLQ 22) which calculates the target damping force in the roll direction of the vehicle based on the roll GSPᵣ and the calculation result of the roll motion calculation unit, and the pitch BLQ (pitch damping BLQ 23) which calculates the target damping force in the pitch direction of the vehicle based on the pitch GSPₚ and the calculation result of the pitch motion calculation unit. The actual target damping force calculation unit calculates the actual target damping force based on the target damping force (heave target damping force) calculated by the heave BLQ, the target damping force (roll target damping force) calculated by the roll BLQ, and the target damping force (pitch target damping force) calculated by the pitch BLQ.

Thus, the actual target damping force calculation unit (sprung vertical damping BLQ 21, roll damping BLQ 22, pitch damping BLQ 23, and target damping force calculation unit 24) can calculate the actual target damping force based on the calculation result of the roll motion calculation unit in addition to the calculation results of the vertical motion calculation unit and the pitch motion calculation unit. That is, the controller 11 can control the damping force of the variable damper 7 based on, in addition to the heave target damping force for suppressing the vertical vibration of the sprung part and the pitch target damping force for suppressing the pitch vibration, the roll target damping force for suppressing the roll vibration. As a result, in addition to the vertical vibration and the pitch vibration of the sprung part, the roll vibration can also be reduced.

In the first embodiment, the controller 11 calculates the actual target damping force based on the weight coefficients (heave GSP, roll GSPᵣ, and pitch GSPₚ) and the vehicle state (the inter-sprung part-unsprung part relative speed, the vehicle body absolute vertical speed (sprung speed), the inter-unsprung part-road surface relative speed, the unsprung absolute vertical speed (unsprung speed), the roll rate, the roll angle, the pitch rate, and the pitch angle). Thus, it is not required to solve again the Riccati equation, and the weight coefficients (heave GSP, roll GSPᵣ, and pitch GSPₚ) are adjusted to reduce the tuning parameters. As a result, it is possible to easily tune the controller 11 (sprung vertical damping BLQ 21, roll damping BLQ 22, and pitch damping BLQ 23).

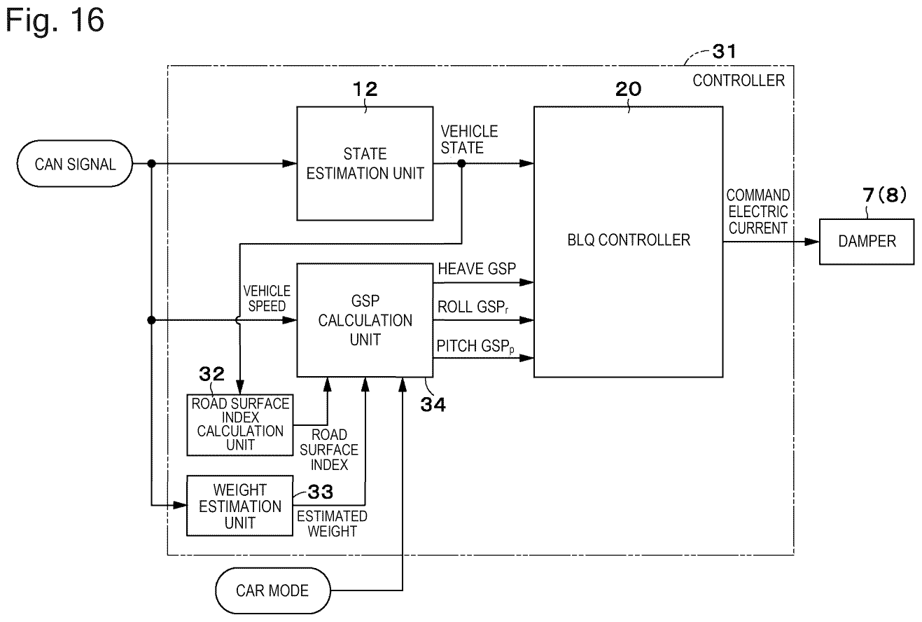

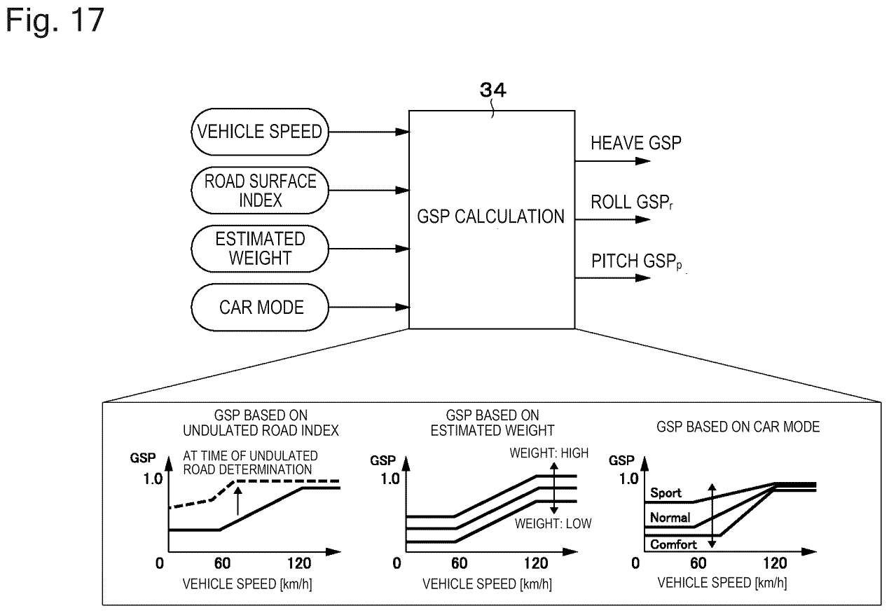

Next, FIG. 1, FIG. 2, FIG. 16, and FIG. 17 are diagrams for illustrating a second embodiment of the present invention. A feature of the second embodiment is that the weight coefficient calculation unit changes the coefficients in accordance with the state of the road surface, the weight of the vehicle, and a selected damping force mode. In the second embodiment, the same components as those of the first embodiment described above are denoted by the same reference symbols, and description thereof is omitted.

A controller 31 according to the second embodiment forms a control device for the variable dampers 7, and controls the damping characteristic of the variable damper 7 (see FIG. 1 and FIG. 2). The controller 31 is configured in substantially the same way as in the controller 11 according to the first embodiment. The controller 31 is formed of, for example, a microcomputer, and is connected to the CAN 9. The controller 31 acquires the specifications relating to the travel of the vehicle through the CAN 9. An output side of the controller 31 is connected to the damping force variable actuator 8 of the variable damper 7.

Moreover, the controller 31 includes a storage unit 31A formed of a ROM, a RAM, a nonvolatile memory, and the like. In the storage unit 31A of the controller 31, various programs, information (vehicle information), data, and the like for controlling the variable dampers 7 are stored.

As illustrated in FIG. 16, the controller 31 includes the state estimation unit 12, a GSP calculation unit 34, and the BLQ controller 20. In addition thereto, the controller 31 includes a road surface index calculation unit 32 and a weight estimation unit 33.

The road surface index calculation unit 32 acquires, for example, the sprung speed and the like from the state estimation unit 12, and uses the sprung speed and the like to output the road surface index. The road surface index calculation unit 32 estimates a vertical acceleration of the vehicle body 2 (sprung part) from the sprung speed and the like. The road surface index calculation unit 32 includes, for example, a band-pass filter or the like, and extracts, from the sprung vertical acceleration, an undulated road component in a predetermined frequency band (for example, from 0.5 Hz to 2 Hz). The road surface index calculation unit 32 outputs, to the GSP calculation unit 34, the road surface index (undulated road index) corresponding to a magnitude (undulated road level) of the undulated road component. At this time, when the undulated road component is not extracted, and hence is the minimum value, the road surface index corresponding to the undulated road is 0. Meanwhile, when the undulated road component takes the maximum value, the road surface index corresponding to the undulated road is 1. As described above, the road surface index takes the value normalized to the range of from 0 to 1. That is, the road surface index is obtained by indexing the vertical, pitch, and roll motions (from 0.5 Hz to 2 Hz) of the vehicle body 2 caused by the road surface input in the range of from 0 to 1.

The road surface index calculation unit 32 is not limited to the configuration which acquires the sprung speed and the like from the state estimation unit 12, but may acquire a detection value of a vertical acceleration sensor, to thereby calculate the road surface index. Moreover, the road surface index calculation unit 32 may acquire, from a camera or the like, road surface information in a travel direction of the vehicle, to thereby calculate the road surface index.

The weight estimation unit 33 acquires, for example, the absolute vertical displacement of the vehicle body 2 and the like based on the CAN signal. The weight estimation unit 33 estimates the weight of the vehicle body 2 based on the absolute vertical displacement of the vehicle body 2 and the like, and outputs the estimated weight to the GSP calculation unit 34. The weight estimation unit 33 is not limited to the configuration which estimates the weight of the vehicle body 2 from the absolute vertical displacement of the vehicle body 2 and the like, and may estimate the weight of the vehicle body 2 based on, for example, a signal from a stroke sensor which detects a stroke of the variable damper 7. The weight estimation unit 33 may acquire a detection value from a weight sensor which detects the weight of the vehicle body, to thereby obtain the weight of the vehicle body 2.

The GSP calculation unit 34 (gain scheduling parameter calculation unit) forms the weight coefficient calculation unit which calculates weight coefficients for causing an actual target damping force based on the calculated values of the state estimation unit 12 (vehicle behavior calculation unit) to approach a value close to a target damping force obtained in advance. To the GSP calculation unit 34, for example, the vehicle speed acquired from the CAN 9, the road surface index from the road surface index calculation unit 32, and the estimated weight from the weight estimation unit 33 are input. In addition thereto, to the GSP calculation unit 34, the car mode serving as the damping force mode is input. In this case, the car mode includes, for example, three types of modes being a normal mode (Normal), a sport mode (Sport), and a comfort mode (Comfort). The car mode is selected through use of, for example, a mode selection switch (not shown) provided to the vehicle. The GSP calculation unit 34 calculates the heave GSP, the roll GSPᵣ, and the pitch GSPₚ based on the vehicle speed, the road surface index, the weight estimation unit, and the car mode. The car mode is not limited to the three types of modes, and may include two types of modes or four or more types of modes.

That is, the GSP calculation unit 34 calculates, when the BLQ controller 20 obtains the actual target damping force based on the vehicle state being the calculated values of the state estimation unit 12 (vehicle behavior calculation unit) (for example, the inter-sprung part-unsprung part relative speed, the vehicle body absolute vertical speed, the inter-unsprung part-road surface relative speed, the unsprung absolute vertical speed, the roll rate, the roll angle, the pitch rate, the pitch angle, and the like), the weight coefficients (heave GSP, roll GSPᵣ, and pitch GSPₚ) for causing the actual target damping force to approach a value close to the target damping force obtained in advance. The GSP calculation unit 34 outputs the heave GSP, the roll GSPᵣ, and the pitch GSPₚ to the BLQ controller 20.

As illustrated in FIG. 17, the GSP calculation unit 34 includes, for example, lookup tables each of which records a relationship between each of the vehicle speed, the road surface index, the estimated weight, and the car mode and each of the heave GSP, the roll GSPᵣ, and the pitch GSPₚ. In this configuration, the heave GSP, the roll GSPᵣ, and the pitch GSPₚ are determined through the tuning in the actual vehicle test. Specifically, the rough characteristic of the heave GSP is determined through sensory evaluation in the actual vehicle test, and then, the heave GSP is finely adjusted by referring to vibration data and the like. Moreover, the GSP calculation unit 34 includes the lookup table which records the relationship between each of the vehicle speed, the road surface index, the estimated weight, and the car mode and the roll GSP and the lookup table which records the relationship between each of the vehicle speed, the road surface index, the estimated weight, and the car mode and the pitch GSP. The roll GSPᵣ and the pitch GSPₚ are also determined, in the same manner as in the heave GSP, through the tuning in the actual vehicle test.

The GSP calculation unit 34 calculates, as illustrated in, for example, FIG. 17, the heave GSP having a small value at a low speed and the heave GSP having a large value at a high speed. When the GSP calculation unit 34 makes an undulated road determination based on the road surface index, the GSP calculation unit 34 increases the value of the heave GSP. The GSP calculation unit 34 sets a larger value as the heave GSP at the time of a large estimated weight as compared with that at the time of a small estimated weight. The GSP calculation unit 34 sets a larger value as the heave GSP at the time of the sport mode in the car mode as compared with that at the time of the normal mode in the car mode. The GSP calculation unit 34 sets a smaller value as the heave GSP at the time of the comfort mode in the car mode as compared with that at the time of the normal mode in the car mode. The GSP calculation unit 34 calculates the roll GSPᵣ and the pitch GSPₚ corresponding to the vehicle speed, the road surface index, the estimated weight, and the car mode in the same manner as that for the heave GSP.

In FIG. 17, the case in which the GSP calculation unit 34 includes the three types of lookup tables corresponding to the road surface index, the estimated weight, and the car mode is exemplified. The GSP calculation unit 34 calculates the heave GSP, the roll GSPᵣ, and the pitch GSPₚ in consideration of those three types of lookup tables. The present invention is not limited to this case, and the GSP calculation unit 34 may calculate the heave GSP, the roll GSPᵣ, and the pitch GSPₚ based on a single lookup table obtained by unifying the three types of lookup tables of FIG. 17.

As described above, also in the second embodiment, the actions and effects substantially the same as those in the first embodiment can be provided. In the second embodiment, the weight coefficient calculation unit (GSP calculation unit 34) changes the coefficients in accordance with the state of the road surface. Thus, it is possible to increase the ride comfort and the vehicle stability by changing the actual target damping force in accordance with the state of the road surface. The weight coefficient calculation unit (GSP calculation unit 34) changes the coefficients in accordance with the weight of the vehicle body 2. Thus, it is possible to increase the ride comfort and the vehicle stability by changing the actual target damping force in accordance with the weight of the vehicle body 2. The weight coefficient calculation unit (GSP calculation unit 34) changes the coefficients in accordance with the selected damping force mode (car mode). Thus, it is possible to increase the ride comfort and the vehicle stability by changing the actual target damping force in accordance with the selected car mode.

In the second embodiment, the GSP calculation unit 34 calculates the weight coefficients (heave GSP, roll GSPᵣ, and pitch GSPₚ) based on the road surface index, the estimated weight, and the car mode, but the present invention is not limited to this example. The GSP calculation unit 34 may calculate the weight coefficients (heave GSP, roll GSPᵣ, and pitch GSPₚ) based on one or two of the road surface index, the estimated weight, and the car mode.

Moreover, in the second embodiment, the case in which the road surface index is the undulated road index has been exemplified, but the present invention is not limited to this case. The road surface index may also be an index corresponding to a state of the road surface other than the undulated road, for example, a rough road.

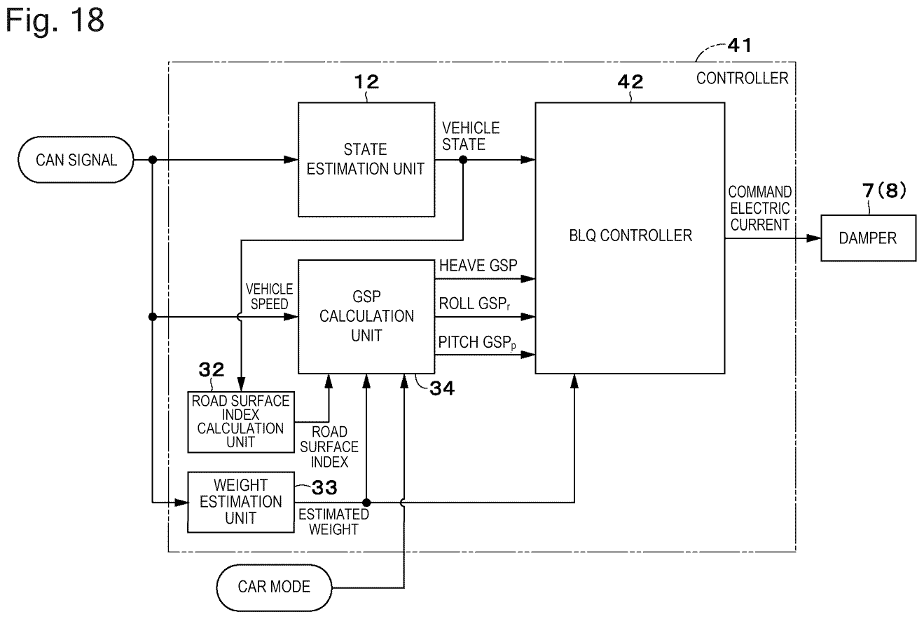

Next, FIG. 1, FIG. 2, and FIG. 18 to FIG. 22 are diagrams for illustrating a third embodiment of the present invention. A feature of the third embodiment is that the weight coefficient calculation unit changes the coefficients in accordance with a front-rear weight balance of the vehicle body and the weight of the vehicle body obtained in advance. In the third embodiment, the same components as those of the first embodiment and the second embodiment described above are denoted by the same reference symbols, and description thereof is omitted.

A controller 41 according to the third embodiment forms a control device for the variable dampers 7, and controls the damping characteristic of the variable damper 7 (see FIG. 1 and FIG. 2). The controller 41 is configured in substantially the same way as in the controller 11 according to the first embodiment. The controller 41 is formed of, for example, a microcomputer, and is connected to the CAN 9. The controller 41 acquires the specifications relating to the travel of the vehicle through the CAN 9. An output side of the controller 41 is connected to the damping force variable actuator 8 of the variable damper 7.

Moreover, the controller 41 includes a storage unit 41A formed of a ROM, a RAM, a nonvolatile memory, and the like. In the storage unit 41A of the controller 41, various programs, information (vehicle information), data, and the like for controlling the variable dampers 7 are stored.

As illustrated in FIG. 18, the controller 41 includes the state estimation unit 12, the GSP calculation unit 34, and a BLQ controller 42. In addition thereto, the controller 31 includes the road surface index calculation unit 32 and the weight estimation unit 33.

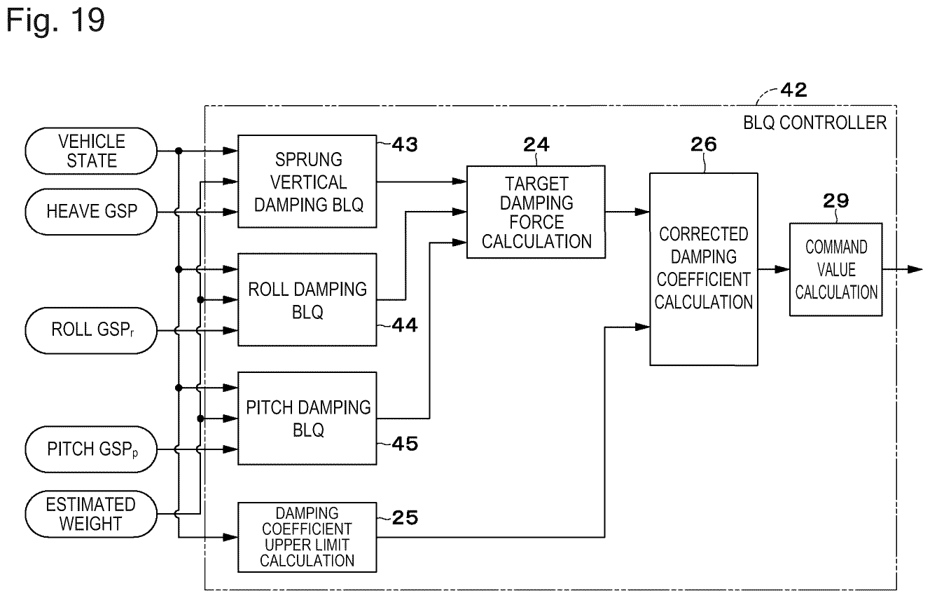

The BLQ controller 42 calculates the command electric current (control signal) serving as the command value based on the bilinear optimal control theory. The BLQ controller 42 is configured in the same manner as in the BLQ controller 20 in the first embodiment. In this configuration, as illustrated in FIG. 19, the BLQ controller 42 includes a sprung vertical damping BLQ 43, a roll damping BLQ 44, a pitch damping BLQ 45, the target damping force calculation unit 24, the damping coefficient upper limit calculation unit 25, the corrected damping coefficient calculation unit 26, and the command value calculation unit 29.

The sprung vertical damping BLQ 43 is configured in the same manner as in the sprung vertical damping BLQ 21 in the first embodiment. To the sprung vertical damping BLQ 43, the vehicle state output from the state estimation unit 12, the heave GSP output from the GSP calculation unit 34, and the estimated weight output from the weight estimation unit 33 are input. The sprung vertical damping BLQ 43 calculates, for each of the front wheel and the rear wheel, the heave target damping force of the variable damper 7 for reducing the vertical vibration based on the inter-sprung part-unsprung part relative speed, the vehicle body absolute vertical speed, the inter-unsprung part-road surface relative speed, and the unsprung absolute vertical speed output from the state estimation unit 12, the heave GSP output from the GSP calculation unit 34, and the estimated weight output from the weight estimation unit 33.

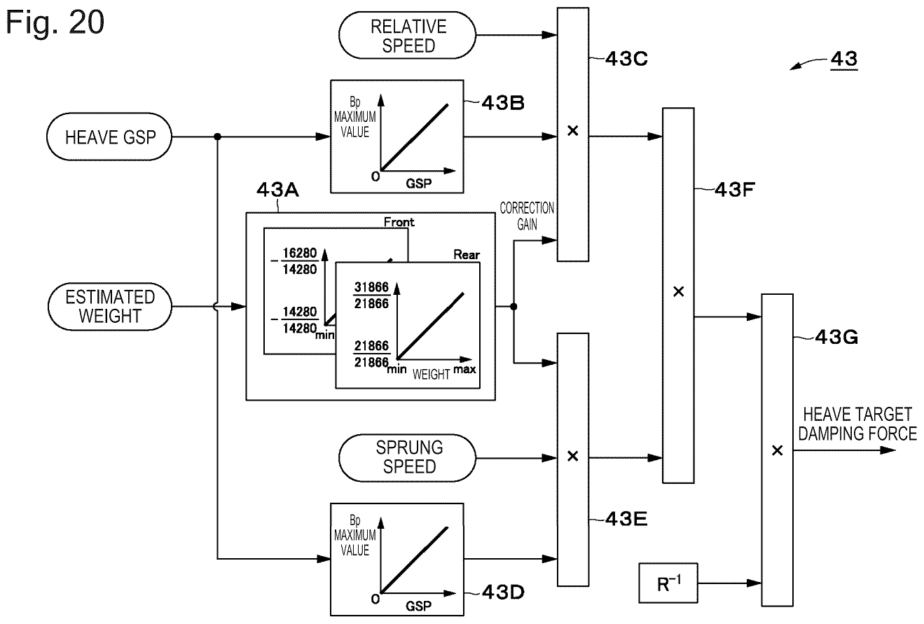

As illustrated in FIG. 20, the sprung vertical damping BLQ 43 includes a corrected gain calculation unit 43A, a Bp calculation unit 43B, a multiplier 43C, a Bp calculation unit 43D, a multiplier 43E, a multiplier 43F, and a heave target damping force calculation unit 43G. The corrected gain calculation unit 43A calculates a corrected gain for the front wheel and a corrected gain for the rear wheel based on the estimated weight. The Bp calculation unit 43B obtains, based on Bp obtained in advance and the heave GSP, the maximum value of Bp corresponding to the relative speed. The multiplier 43C multiplies each of the corrected gains output from the corrected gain calculation unit 43A, the maximum value of Bp output from the Bp calculation unit 43B, and the relative speed by one another. The Bp calculation unit 43D obtains, based on Bp obtained in advance and the heave GSP, the maximum value of Bp corresponding to the sprung speed. The multiplier 43E multiplies each of the corrected gains output from the corrected gain calculation unit 43A, the maximum value of Bp output from the Bp calculation unit 43D, and the sprung speed by one another. The multiplier 43F multiplies each of calculated values obtained by the multiplier 43C and each of calculated values obtained by the multiplier 43E by each other. The heave target damping force calculation unit 43G multiplies each of calculated values obtained by the multiplier 43F and the inverse matrix (R⁻¹) of R obtained in advance by each other, to thereby calculate each of the heave target damping force for the front wheel and the heave target damping force for the rear wheel. The case in which the sprung vertical damping BLQ 43 calculates the heave target damping force based on Bp corresponding to the relative speed and Bp corresponding to the sprung speed has been exemplified, but the present invention is not limited to this example. The sprung vertical damping BLQ 43 may calculate the heave target damping force based on Bp corresponding to another vehicle state in addition to Bp corresponding to the relative speed and Bp corresponding to the sprung speed.

To the roll damping BLQ 44, the vehicle state output from the state estimation unit 12, the roll GSPᵣ output from the GSP calculation unit 34, and the estimated weight output from the weight estimation unit 33 are input. The roll damping BLQ 22 calculates, for each of the front wheel and the rear wheel, the roll target damping force of the variable damper 7 for reducing the roll vibration based on the roll rate and the roll angle output from the state estimation unit 12, the roll GSP output from the GSP calculation unit 34, and the estimated weight output from the weight estimation unit 33.

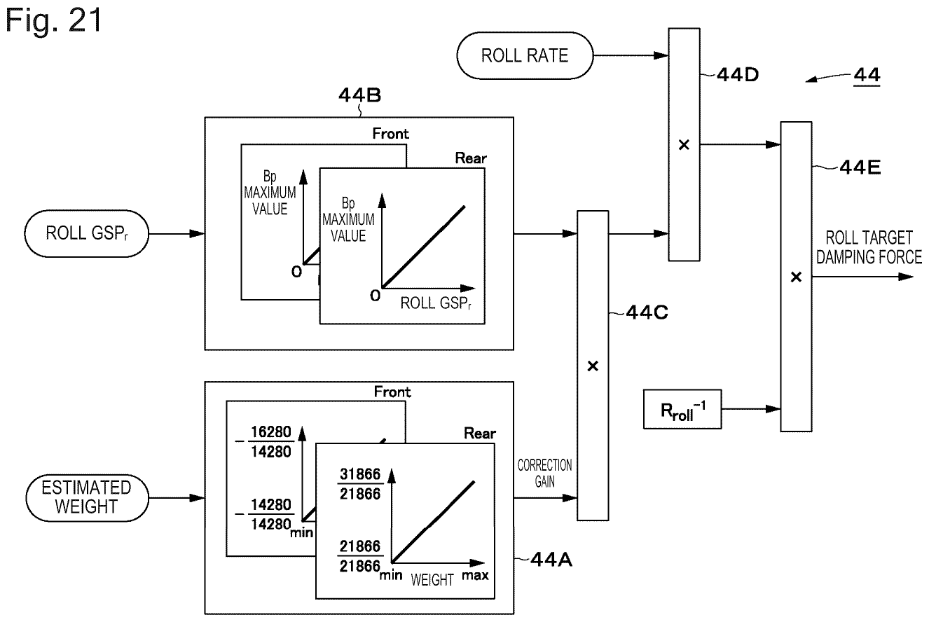

As illustrated in FIG. 21, the roll damping BLQ 44 includes a corrected gain calculation unit 44A, a Bp calculation unit 44B, multipliers 44C and 44D, and a roll target damping force calculation unit 44E. The corrected gain calculation unit 44A calculates a corrected gain for the front wheel and a corrected gain for the rear wheel based on the estimated weight. The Bp calculation unit 44B obtains, based on Bᵣₒₗₗpᵣₒₗₗ obtained in advance and the roll GSPᵣ, the maximum values of Bᵣₒₗₗpᵣₒₗₗ corresponding to the roll rate. The multiplier 44C multiplies each of the corrected gains output from the corrected gain calculation unit 44A and each of the maximum values of Bᵣₒₗₗpᵣₒₗₗ output from the Bp calculation unit 44B by each other. The multiplier 44D multiplies each of calculated values obtained by the multiplier 44C and the roll rate by each other. The roll target damping force calculation unit 44E multiplies each of calculated values obtained by the multiplier 44D and the inverse matrix (Rᵣₒₗₗ⁻¹) of Rᵣₒₗₗ obtained in advance by each other, to thereby calculate each of the roll target damping force for the front wheel and the roll target damping force for the rear wheel.

To the pitch damping BLQ 45, the vehicle state output from the state estimation unit 12, the pitch GSPₚ output from the GSP calculation unit 34, and the estimated weight output from the weight estimation unit 33 are input. The pitch damping BLQ 45 calculates, for each of the front wheel and the rear wheel, the pitch target damping force of the variable damper 7 for reducing the pitch vibration based on the pitch rate and the pitch angle output from the state estimation unit 12 and the pitch GSPₚ output from the GSP calculation unit 34.

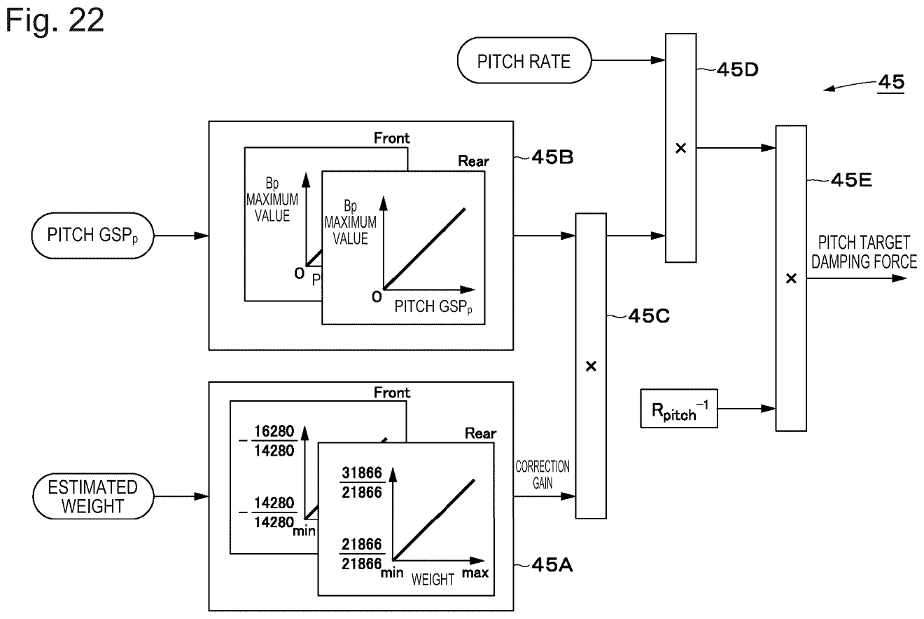

As illustrated in FIG. 22, the pitch damping BLQ 45 includes a corrected gain calculation unit 45A, a Bp calculation unit 45B, multipliers 45C and 45D, and a pitch target damping force calculation unit 45E. The corrected gain calculation unit 45A calculates a corrected gain for the front wheel and a corrected gain for the rear wheel based on the estimated weight. The Bp calculation unit 45B obtains, based on B_{pitch}p_{pitch} obtained in advance and the pitch GSPₚ, the maximum values of B_{pitch}p_{pitch} corresponding to the pitch rate. The multiplier 45C multiplies each of the corrected gains output from the corrected gain calculation unit 45A and each of the maximum values of B_{pitch}p_{pitch} output from the Bp calculation unit 45B by each other. The multiplier 45D multiplies each of calculated values obtained by the multiplier 45C and the pitch rate by each other. The pitch target damping force calculation unit 45E multiplies each of calculated values obtained by the multiplier 45D and the inverse matrix (R_{pitch}⁻¹) of R_{pitch} obtained in advance by each other, to thereby calculate each of the pitch target damping force for the front wheel and the pitch target damping force for the rear wheel.

In this configuration, the GSP calculation unit 34 and the corrected gain calculation units 43A, 44A, and 45A form the weight coefficient calculation unit.

As described above, also in the third embodiment, the actions and effects substantially the same as those in the first embodiment and the second embodiment can be provided. In the third embodiment, the weight coefficient calculation unit (GSP calculation unit 34 and corrected gain calculation units 43A, 44A, and 45A) changes the coefficients in accordance with the front-rear weight balance of the vehicle body 2 and the weight of the vehicle body 2 obtained in advance. Specifically, the heave BLQ (sprung vertical damping BLQ 21), the roll BLQ (roll damping BLQ 22), and the pitch BLQ (pitch damping BLQ 23) calculate the heave target damping force, the roll target damping force, and the pitch target damping force, respectively, in consideration of the front-rear weight balance of the vehicle body. Thus, it is possible to adjust a ratio between the target damping force on the front wheel side and the target damping force on the rear wheel side at a ratio corresponding to the weight of the vehicle. As a result, even when the ride comfort of the vehicle and the vehicle stability change in accordance with the number of occupants and a loading weight of the vehicle and the like, the ride comfort and the like can be increased.

In the third embodiment, the controller 41 includes the GSP calculation unit 34 in the second embodiment, but may include the GSP calculation unit 13 in the first embodiment. Moreover, in the third embodiment, the weight coefficient calculation unit is formed of the GSP calculation unit 34 and the corrected gain calculation units 43A, 44A, and 45A. The present invention is not limited to this configuration, and the GSP calculation unit 34 and the corrected gain calculation units 43A, 44A, and 45A may be unified to form a lookup table, and the weight coefficient calculation unit may be formed of this lookup table.

FIG. 4 and FIG. 17 are diagrams for illustrating an example of the lookup tables forming the GSP calculation units 13 and 34, FIG. 6 is a graph for showing an example of the damping coefficient upper limit calculation unit 25, and FIG. 7 is a graph for showing an example of the command value calculation unit 29, but the present invention is not limited thereto. The GSP calculation units, the damping coefficient upper limit calculation unit, and the command value calculation unit are appropriately set in consideration of the specifications of the vehicle and the like.

In each of the embodiments, description has been given while exemplifying the case in which each of the controllers 11, 31, and 41 acquires the specifications relating to the travel of the vehicle through the CAN 9, but the present invention is not limited thereto. Each of the controllers 11, 31, and 41 may be connected to, for example, acceleration sensors which detect the vertical accelerations of the sprung part and the unsprung part, wheel speed sensors which detect the wheel speeds, and the like, and may acquire detection values of those sensors as the specifications relating to the travel of the vehicle. Moreover, each of the controllers 11, 31, and 41 may acquire the specifications relating to the travel of the vehicle from another controller or the like.

In each of the embodiments, each of the controllers 11, 31, and 41 includes the state estimation unit 12 including the vertical motion calculation unit, the roll motion calculation unit, and the pitch motion calculation unit. In this configuration, the state estimation unit 12 obtains the state of the vehicle relating to the motion in the vertical direction from the CAN signal, obtains the state of the vehicle relating to the motion in the roll direction from the CAN signal, and obtains the state of the vehicle relating to the motion in the pitch direction from the CAN signal. The present invention is not limited to this configuration, and, for example, each of the controllers 11, 31, and 41 may be connected to an acceleration sensor for the vertical direction, a roll sensor, a pitch sensor, and the like, and may calculate, based on detection values of those sensors, the state of the vehicle relating to the motion in the vertical direction, the state of the vehicle relating to the motion in the roll direction, and the state of the vehicle relating to the motion in the pitch direction. In this case, the portions which calculate the respective states out of the controllers 11, 31, and 41 form the vertical motion calculation unit, the roll motion calculation unit, and the pitch motion calculation unit.

In each of the embodiments, description has been given while exemplifying the case in which the damping-force adjustable shock absorber is the variable damper 7 formed of the semi-active damper. The present invention is not limited to this case, and an active damper (any one of an electric actuator or a hydraulic actuator) may be used as the damping-force adjustable shock absorber. In each of the embodiments, description has been given while exemplifying the case in which the damping-force adjustable shock absorber which generates an adjustable force between the vehicle body 2 side and the wheel 3 side is formed of the variable damper 7 formed of a hydraulic shock absorber. The present invention is not limited to this, and for example, as an alternative to the hydraulic shock absorber, the damping-force adjustable shock absorber may be formed of an air suspension, an electromagnetic suspension, or the like.

In each of the embodiments, description has been given while exemplifying the case of a vehicle behavior device to be used for a four-wheeled vehicle. However, the present invention is not limited to this, and may be applicable also to, for example, a two-wheeled vehicle, a three-wheeled vehicle, or a truck or a bus which is a working vehicle or a transport vehicle.

The specific numerical values described in each of the embodiments indicate an example, and are not limited to the exemplified values. Further, the embodiments are examples, and it goes without saying that partial replacement or combination of the configurations presented in different embodiments can be made.

The present invention is not limited to the embodiments described above, and includes further various modification examples. For example, in the embodiments described above, the configurations are described in detail in order to clearly describe the present invention, but the present invention is not necessarily limited to an embodiment that includes all the configurations that have been described. Further, a part of the configuration of a given embodiment can be replaced by the configuration of another embodiment, and the configuration of another embodiment can also be added to the configuration of a given embodiment. Further, another configuration can be added to, deleted from, or replace a part of the configuration of each of the embodiments.

The present application claims a priority based on Japanese Patent Application No. 2022-207940 filed on Dec. 26, 2022. All disclosed contents including Specification, Scope of Claims, Drawings, and Abstract of Japanese Patent Application No. 2022-207940 filed on Dec. 26, 2022 are incorporated herein by reference in their entirety.

### REFERENCE SIGNS LIST

1: vehicle behavior control device, 2: vehicle body, 3: wheel, 5: suspension device, 7: damping-force adjustable shock absorber (variable damper), 8: damping force variable actuator, 9: CAN, 11, 31, 41: controller (control device), 12: state estimation unit (vehicle behavior calculation unit, vertical motion calculation unit, roll motion calculation unit, pitch motion calculation unit, posture change detection unit), 13, 34: GSP calculation unit (weight coefficient calculation unit), 20, 42: BLQ controller, 21, 43: sprung vertical damping BLQ (heave BLQ), 22, 44: roll damping BLQ (roll BLQ), 23, 45: pitch damping BLQ (pitch BLQ), 24: target damping force calculation unit (actual target damping force calculation unit), 25: damping coefficient upper limit calculation unit, 26: corrected damping coefficient calculation unit, 27: target damping coefficient calculation unit (target damping coefficient calculation unit), 28: minimum value selection unit (correction unit), 29: command value calculation unit (control signal output unit), 32: road surface index calculation unit, 33; weight estimation unit

1-10. (canceled)

11. A control device for a damping-force adjustable shock absorber which is provided to a vehicle and which allows adjustment of a damping force to be generated, the control device comprising:
a weight coefficient calculation unit configured to calculate, when an actual target damping force is to be calculated based on a calculated value of a vehicle behavior calculation unit, a weight coefficient for causing the actual target damping force to approach a value close to a target damping force obtained in advance;
a vertical motion calculation unit configured to obtain a motion state of the vehicle in a vertical direction;
a pitch motion calculation unit configured to obtain a motion state of the vehicle in a pitch direction;
an actual target damping force calculation unit configured to calculate the actual target damping force based on the weight coefficient calculated by the weight coefficient calculation unit and a calculation result of the vertical motion calculation unit and a calculation result of the pitch motion calculation unit;
a target damping coefficient calculation unit configured to calculate a target damping coefficient based on a calculated value of the actual target damping force calculation unit;
a correction unit configured to calculate a corrected damping coefficient obtained by reducing an upper limit of the target damping coefficient in a region in which a relative speed between a sprung part and an unsprung part of the vehicle is lower than a predetermined value; and
a control signal output unit configured to output a control signal corresponding to the corrected damping coefficient to the damping-force adjustable shock absorber,
wherein the correction unit is configured to set the corrected damping coefficient such that the damping force increases in accordance with an increase in the relative speed, a gradient of the damping force with respect to the relative speed is small when the relative speed is lower than the predetermined value, and the gradient of the damping force with respect to the relative speed is large when the relative speed is higher than the predetermined value,
wherein the correction unit has a maximum damping coefficient corresponding to the relative speed, and is configured to correct the target damping coefficient to the maximum damping coefficient when the target damping coefficient exceeds the maximum damping coefficient, and
wherein the weight coefficient calculation unit is configured to change the weight coefficient in accordance with a state of a road surface.

12. The control device according to claim 11, further comprising a posture change detection unit configured to detect a posture change in a vehicle body,
wherein the correction unit is configured to reduce a correction amount when the correction unit determines, based on a detection result of the posture change detection unit, that the posture change occurs.

13. The control device according to claim 11, further comprising a roll motion calculation unit configured to obtain a motion state of the vehicle in a roll direction.

14. The control device according to claim 11, wherein the weight coefficient calculation unit is configured to change the weight coefficient in accordance with a weight of a vehicle body.

15. The control device according to claim 11, wherein the weight coefficient calculation unit is configured to change the weight coefficient in accordance with a selected damping force mode.

16. The control device according to claim 11, wherein the weight coefficient calculation unit is configured to change the weight coefficient in accordance with a front-rear weight balance of a vehicle body and a weight of the vehicle body which are obtained in advance.

17. The control device according to claim 11,
wherein the weight coefficient calculation unit is configured to calculate, as the weight coefficient, a heave GSP relating to a motion of the vehicle in the vertical direction and a pitch GSP relating to a motion of the vehicle in the pitch direction,
wherein the actual target damping force calculation unit includes a heave BLQ configured to calculate a target damping force in the vertical direction of the vehicle based on the heave GSP and the calculation result of the vertical motion calculation unit, and a pitch BLQ configured to calculate a target damping force in the pitch direction of the vehicle based on the pitch GSP and the calculation result of the pitch motion calculation unit, and
wherein the actual target damping force calculation unit is configured to calculate the actual target damping force based on the target damping force calculated by the heave BLQ and the target damping force calculated by the pitch BLQ.

18. The control device according to claim 13,
wherein the weight coefficient calculation unit is configured to calculate, as the weight coefficient, a heave GSP relating to a motion of the vehicle in the vertical direction, a roll GSP relating to a motion of the vehicle in the roll direction, and a pitch GSP relating to a motion of the vehicle in the pitch direction,
wherein the actual target damping force calculation unit includes a heave BLQ configured to calculate a target damping force in the vertical direction of the vehicle based on the heave GSP and the calculation result of the vertical motion calculation unit, a roll BLQ configured to calculate a target damping force in the roll direction of the vehicle based on the roll GSP and a calculation result of the roll motion calculation unit, and a pitch BLQ configured to calculate a target damping force in the pitch direction of the vehicle based on the pitch GSP and the calculation result of the pitch motion calculation unit, and
wherein the actual target damping force calculation unit is configured to calculate the actual target damping force based on the target damping force calculated by the heave BLQ, the target damping force calculated by the roll BLQ, and the target damping force calculated by the pitch BLQ.

19. The control device according to claim 18, wherein the heave BLQ, the roll BLQ, and the pitch BLQ are configured to calculate the target damping forces in consideration of a front-rear weight balance of a vehicle body.
